(19) United States
(12) Patent Application Publication
(10) Pub. No.: US 2011/0104501 A1
(43) Pub. Date: May 5, 2011

(54) Emulsions Useful for Coatings and Coating Additives

(75) Inventors: Fredric Watson, New London, NC (US); Ronald Obie, High Point, NC (US)

(73) Assignee: The Wood Coatings Research Group,, Greensboro, NC (US)

(21) Appl. No.: 11/885,468

(22) PCT Filed: Feb. 28, 2006
(86) PCT No.: PCT/US2006/006967

§ 371 Date: Jun. 19, 2009

Related U.S. Application Data
(60) Provisional application No. 60/656,886, filed on Mar. 1, 2005.

(51) Int. Cl. C08K 5/17; C08L 75/04; B32B 27/40

(52) U.S. Cl. 428/425.1; 524/186; 524/507

(57) ABSTRACT

The invention relates to a method of preparing aqueous emulsions of resins and additives, to provide coating compositions and additives which maintain solvent-like application and performance properties yet have reduced volatile organic content. The compositions and additives contain an organic phase, an aqueous phase, and an emulsifier. The emulsifier is preferably a polyolefin aminoester, a substituted alkanolamine, or a mixture thereof, a polyalkylene glycol ether, or an orange oil emulsifier. The compositions of the invention are particularly useful as coatings and coating additives that are applied to substrates, such as wood and plastics.

### BACKGROUND OF THE INVENTION

1. Field of the Invention

The invention relates to methods of preparing emulsions for coating compositions and coating additives, to the resulting compositions and additives, and to their use.

2. Related Art

In an increasing number of industries, aqueous coating compositions continue to replace traditional organic solvent-based coating compositions. Paints, primers, stains, sealants, and adhesives, for example, previously formulated with organic solvents are now formulated as aqueous compositions. This reduces potentially harmful exposure to volatile organic compounds (VOC's) commonly found in organic solvent-based compositions. The need to meet or exceed such performance standards places a premium on the characteristics and properties of such aqueous coating compositions.

Thus, there is a continuing need for compositions that maintain solvent-like application and performance properties, with reduced VOC content.

### SUMMARY OF THE INVENTION

The invention provides aqueous coating compositions for application to a substrate, in the form of an emulsion. The aqueous coating composition includes an organic phase having a substrate coating resin, an aqueous phase (which can be an aqueous emulsion, dispersion, or solution), and an emulsifier in an amount sufficient to emulsify the organic and aqueous phases. The invention also provides methods of making the compositions, as well as applying such compositions to substrates.

The invention also provides aqueous coating additives that can be added to coating compositions, in the form of an emulsion. An aqueous coating additive includes an organic phase having a hydrophobic additive, an aqueous phase (which can be an aqueous emulsion, dispersion, or solution), and an emulsifier in an amount sufficient to emulsify the organic and aqueous phases. The invention also provides methods of making the coating additives, as well as use of such additives in coating compositions.

In embodiments of the invention, the emulsifier includes a polyolefin aminoester, a substituted alkanolamine, or a mixture thereof. In other embodiments, the emulsifier includes a polyalkylene glycol ether. In still yet other embodiments, the emulsifier includes Videt ME-80 anionic emulsifier.

The aqueous coating compositions and additives of the invention are advantageous in forming emulsions with hydrophobic media, including resins and additives that cannot typically be used in an aqueous environment. Further, compositions of the invention maintain solvent-like application and performance properties, with reduced VOC content compared to non-aqueous compositions.

Illustrative coating compositions include emulsions containing hydrophobic resins useful as sizing, coating, staining, priming, or textile resins and treatments. Descriptive additives that can be used in the present invention include waxes, silicones, fluorocarbons, and UV absorbers, and more generally for any additive that is not typically soluble in water.

### DETAILED DESCRIPTION OF THE INVENTION

The invention provides emulsions of an aqueous phase and an organic phase, which are useful as coatings and coating additives with reduced VOC content.

In an embodiment of the invention, an aqueous coating composition is provided. The aqueous coating composition includes an organic phase comprising a substrate coating resin, an aqueous phase, and an amount of an emulsifier sufficient to emulsify the aqueous and organic phases.

The term “aqueous coating composition” is intended to encompass compositions containing an aqueous phase (e.g., water) that are applied to substrates. Illustrative coatings that can utilize the composition of the invention include wood coatings such as, e.g., stains, seal coat/sealers, topcoats, wiping stains, glazes, and fillers. Examples of other coatings include paints (e.g., house paints), primers, architectural coatings, industrial coatings, maintenance coatings, general metal-type coatings, paper coatings including textile treatments, plastics coatings such as primers, base coats, top coats, and adhesion promoters, and polishes. Other suitable coatings that are embodied by the aqueous coating compositions of the invention can be found in “Paint & Ink Formulations Database” by Earnest W. Flick, 2005; William Andrew—publisher; ISBN: 0815515081; and Paint and Surface Coatings: Theory and Practice, 2^{nd} Ed. By R. Lambourne and T. A. Striven, eds., 1999; William Andrew—publisher; ISBN: 18884207731; and “Organic Coatings: Science and Technology, 2^{nd} Ed; by Zeno W. Wicks, Frank N. Jones, and S. Peter Pappas, 1999; —Wiley-Interscience; ISBN:0471245070, all incorporated by reference herein.

The term “substrate coating resin” is intended to encompass hydrophobic resins that can be incorporated into aqueous compositions of the invention that are suitable for coating a substrate. Suitable resins include but are not limited to one or more of a silicone-modified polymer, a perfluorinated polymer, a chlorinated polyolefin, a nonchlorinated polyolefin, a hydroxyl-functional polymer, an acrylic, a polyester, a modified polyester (e.g., amine-modified), a polyether, an acrylate-functional resin, an acrylated acrylic, an acrylated polyester, an acrylated polyether, an acrylated polyurethane, an acrylated epoxy, an amine-modified acrylated acrylic, an amine-modified polyether, an unsaturated polyester, an allyl-functional polymer, styrene allyl alcohol, a non-water soluble polyol, an air-oxidizable initiator/crosslinker, a phenoplast resin, an aminoplast resin, an oil, a fat, a fatty acid, a resin derived from an oil, fat, or fatty acid, a plasticizer, a hydroxyl-terminated polybutadiene resin or derivative thereof, a maleic-modified resin, an ethylene vinyl acetate copolymer, a styrene-butadiene copolymer, a styrene-isoprene copolymer, an acrylic copolymer, a butadiene-based polymer, an alkyd resin, a modified alkyd resin including styrene, vinyl toluene and urethane-modified alkyds, and an aliphatic or aromatic hydrocarbon resin.

Suitable oils and fats and resins derived there from that can be used as part of the substrate coating resin of the invention include those described in Bailey's Industrial Oil and Fat Products, Volume 1, 4th edition, edited by Daniel Swern, copyright John Wiley and Sons; ISBN: 0-471-83957-4.

In another embodiment of the invention, an aqueous coating additive is provided. The additive includes an organic phase having one or more hydrophobic additives, an aqueous phase, and an amount of an emulsifier sufficient to emulsify the aqueous and organic phases.

The hydrophobic additives that can be used in the aqueous coating additive of the invention include photoinitiators, defoamers (e.g., silicone), antioxidants, waxes, colorants, pigments, dyes, rheology modifiers, anti-settling agents, dispersants, antimar agents, UV absorbers, light stabilizers, catalysts, crosslinkers, redox catalysts, flow and leveling agents, wetting agents, catalysts, sunscreens, biocides, plasticizers, and water repellants. Other suitable hydrophobic additives that can be used in the aqueous coating additive of the invention are described in the textbook Handbook of Coatings Additives, 2^{nd} Ed. By John J. Florio and Daniel J. Miller, eds., 2004; publisher Marcel Dekker; ISBN: 0824756266; and Additives for Coatings by Johan Bieleman, ed., 2000; Publisher—Wiley—VCH; ISBN: 3527297855, which are incorporated by reference herein.

Other hydrophobic moieties that can be incorporated into the aqueous coating compositions and additives according to the invention include the resins and additives described on pages 10-15 of International Publication No. WO 2004/030801, such as, for example, different types of silicones, waxes, chlorinated polymers, polyols/hydroxy functional polymers, unsaturated and UV-curable resins and oligomers, photoinitiators/additive stabilizers, and aminoplast and phenoplast resins. Page 10, line 1 to p. 15, line 18 of WO 2004/030801 is specifically incorporated by reference herein.

The aqueous phase of the coating compositions and coating additives of the invention is typically water, but may also include components which are soluble in and/or dissolved in and/or dispersed into water or an aqueous phase. Such components include but are not limited to catalysts, salts, polymers, dyes, and pigments. The aqueous phase may also include a water-co-solvent blend.

For example, one or more pigments may be dispersed in the aqueous phase of the coating compositions of the invention. The types of pigments that can be used in the invention are not particularly limited and are known to those skilled in the art. Illustrative pigments include titanium dioxide, silica, silicates such as aluminum silicate and sodium potassium alumino silicate. Other pigments that can be used in the invention are described in the textbook Pigment Handbook, Properties and Economics, 2^{nd} ed. By Peter A. Lewis (Editor), Wiley-Interscience; 2^{nd} edition, 1988, ISBN: 0471828335, incorporated by reference herein.

The aqueous phase containing the one or more pigments may also include wetting and/or dispersing agents. Illustrative wetting and dispersing agents include, but are not limited to modified acetylenic diols and pigment wetting and dispersing agents such as those manufactured by Air Products and Chemicals (Allentown, Pa.), alkyl phenol ethoxylates, alcohol ethoxylates, sulfosuccinates, sulfates and sulfonates such as those manufactured by Union Carbide/Dow Chemical, (Midland, Mich.), and high molecular weight wetting and dispersing additives such as the Disperbyk line marketed by Byk-Chemie USA (Wallingford, Conn.) (for example Disperbyk 190, 191, and 194). Other wetting and dispersing aids (including surfactants) useful for the invention include those mentioned in the books “Surfactants and Interfacial Phenomena” by Milton J. Rosen, Wiley-Interscience; 3rd edition, 2004; ISBN: 0471478180 and “Surfactants: Chemistry, Interfacial Properties, Applications (Studies in Interface Science)” by D. Möbius, R. Miller, V. B. Fainerman, Elsevier Science; Bk&CD-Rom edition, 2001; ISBN: 0444509623, and “Performance Enhancement in Coatings by Edward W. Orr, Hanser Publishers, Munich, 1998; ISBN: 3-446-19405-3 all incorporated herein for reference.

In an embodiment of the invention, the aqueous phase is in itself an emulsion. In a “dual emulsion” of the invention, in the presence of a hydrophobic material (e.g., a chlorinated polyolefin), instead of emulsifying water, another emulsion is emulsified, such as an aqueous latex or acrylic emulsion. Such a dual emulsion enables the performance properties of a very high molecular weight latex to be delivered to a substrate with the application properties of a solution coating. A dual emulsion also enables water soluble items (such as catalysts, or reactive moieties, for example) to be delivered to a substrate in the presence of a reactive polymer, all in the same package.

Latexes, dispersions, and emulsions that may be incorporated into the dual emulsion are not particularly limited. Illustrative latexes include an acrylate-styrene copolymer, straight acrylics, vinyl acrylics, latexes based on vinyl esters of the C9-C11 versatic acids, vinyl acetate-based emulsions, vinyl chloride acrylic copolymers, vinylidine chloride terpolymers, styrene-butadiene copolymers, polyurethane dispersions, polyurethane-acrylic hybrids, and self-crosslinking latexes. Both emulsions and dispersions (such as alkyd dispersions) are useful as part of the dual emulsion. Specific examples include styrene acrylic emulsion H595 (Alberdingk Boley; Greensboro, N.C.), acrylic emulsion AC2538 (Alberdingk Boley); CR712 acrylic emulsion (Noveon; Cleveland, Ohio); Rhoshield 3188 self-crosslinking emulsion (Rohm and Haas Co.; Philadelphia, Pa.); and polyurethane dispersions Sancure 843 (Noveon) and Hybridur 570 (Air Products and Chemicals; Allentown, Pa.).

The emulsifier used in the aqueous coating compositions and additives of the invention can be one or more of the emulsifiers described on page 12, line 14 through page 27, line 11 of International Publication No. WO 2004/055137, the publication incorporated herein by reference. Also, the emulsifier used in the compositions of the invention can include one or more of the emulsifiers or dispersants disclosed in, and more specifically the polyisobutenyl aminosuccinate derivative emulsifiers or dispersants disclosed in, U.S. Pat. Nos. 6,783,746; 6,780,209; 6,770,605; 6,648,929; 6,368,367; 6,383,237; 6,280,485; 6,165,235; and 5,885,944; all incorporated by reference herein.

Preferably, the emulsifier used in the compositions and additives of the invention is a polyolefin aminoester, a substituted alkanolamine, or a mixture thereof. Suitable emulsifiers include ethanoldiethonium polyisobutenyl triethylaminosuccinate, TEA-diethanolaminoethyl polyisobutenyl succinate, glyceryl polyisobutenyl succinate, or mixtures thereof. For example, ethanoldiethonium polyisobutenyl triethylaminosuccinate available under the trade name Chemccinate® 5603, TEA-diethanolaminoethyl polyisobutenyl succinate and ethylhexyl palmitate succan-based emulsifier available under the trade name Chemccinate® 2000, glyceryl polyisobutenyl succinate and ethylhexyl palmitate and glycerin succan-based emulsifier available under the trade name Chemccinate® 1000AF, all from Chemron Corporation (Paso Robeles, Calif.), or mixtures thereof are suitable emulsifiers for the compositions and additives of the invention.

In another embodiment of the invention, the emulsifier is a polyalkylene glycol ether having a molecular weight of about 2000 to about 4000. An illustrative polyalkylene glycol ether for use in the compositions and additives of the invention is an alkyl ethylene oxide/propylene oxide copolymer having a molecular weight of about 3000, such as Tergitol® XD available from Dow/Union Carbide, Houston, Tex.

In yet another embodiment of the invention, the emulsifier is the orange oil anionic emulsifier Videt ME-80, available from Vitech International Inc., Janesville, Wis.

The amounts of the organic phase, aqueous phase, and emulsifier in the aqueous coatings and additives of the invention are not particularly limited and will depend upon, e.g., the desired properties of the coating or additive. Illustratively, the aqueous coating composition or additive can contain, by weight of the composition, about 5% to about 60% of an organic phase, about 1% to about 95% of an aqueous phase, and about 0.5% to about 30% by weight of an emulsifier.

The aqueous compositions and additives of the invention can be prepared by combining a hydrophobic or organic phase, an aqueous phase, and an emulsifier, and forming an emulsion according to methods known by those skilled in the art.

In an embodiment, the emulsifier or mixture of emulsifiers is mixed into or dissolved in a compatible solvent and/or the hydrophobic moiety. Additional additives or chemicals are added as required to build any special end use and/or application property. Water may then added under shear or agitation to prepare an emulsion.

The viscosity of the hydrophobic resin or additive can be reduced by the addition of a solvent prior to preparation of the emulsion. Alternatively or additionally, the resin or additive can be solubilized. Suitable solvents include but are not limited to aliphatic hydrocarbons, such as, for example, White Spirit, isooctane, cyclopentane, and cyclohexane, methylcyclohexane, dipentene, and turpentine; aromatic hydrocarbons, such as, for example aromatic 100, 150, and 200, toluene, and xylenes; esters, ketones such as, for example cyclohexanone, 2-heptanone, and methyl-isobutyl ketone; ethers, parachlorobenzotrifluoride, and chlorinated solvents. Other suitable solvents include those listed in the Handbook of Solvents by George Wypych, ed., 2001; Publisher—ChemTec Publishing; ISBN: 0815514581; and Surface Coatings: Science and Technology, 2^{nd} Ed. By Paul Swaraj, 1996; Publisher—John Wiley & Sons; ISBN: 0471958182, which are incorporated by reference herein.

When a solvent is used, the aqueous coating compositions and coating additives are preferably prepared by combining the solvent, the aqueous phase, and the emulsifier to form an emulsion, and subsequently adding the resin or additive. However, a resin or additive may be dissolved with the solvent, with one or more additional resins being added after the emulsion is formed.

In embodiments of the invention, the aqueous compositions and additives form a water-in-oil emulsion. For example, a water-in-oil emulsion is typically formed when the emulsifier used includes a polyolefin aminoester, a substituted alkanolamine, or a mixture thereof, or Videt ME-80.

In other embodiments of the invention, the aqueous compositions and additives form an oil-in-water emulsion. For example, an oil-in-water emulsion is typically formed when the emulsifier used includes a polyalkylene glycol ether such as Tergitol® XD.

An illustrative aqueous coating composition or coating additive is formed by combining a chlorinated polyolefin dissolved in a solvent with the aqueous phase and an emulsifier and agitating to form an emulsion, and adding an additional resin or additive. Use of a chlorinated polyolefin in aqueous coating compositions and coating additives of the invention improves emulsion properties and results in an enhanced cure, particularly when used with UV-curable materials.

As mentioned above, the compositions and coating additives of the invention are particularly useful for and intended for application to a substrate, to produce articles of manufacture with the composition applied thereto. Illustrative substrates to which the compositions of the invention can be applied include wood, composites, textiles and nonwovens, paper, exterior siding, sheetrock, and any other substrate for which a coating might be useful.

Illustrative applications of the invention include stains (e.g. a deck stain), adhesion promoters to plastic (e.g. to thermoplastic olefin plastic (TPO)), paints, primers, and other coatings. Other applications of the invention are described in the Examples, below.

Stains and primers of the invention include an organic phase, an aqueous phase, and an emulsifier as described above. The organic phase can include a resin and/or a solvent, and optionally one or more additives.

Resins used in the stains and primers of the invention include but are not limited to alkyds, including soya oil-modified (long, medium, and short-soya), linseed oil-modified, tung oil-modified, coconut oil-modified, tall oil-modified, palm-oil-modified, castor-oil modified, avocado oil-modified, canola oil-modified, corn oil-modified, fish oil-modified, peanut oil-modified, rapeseed oil-modified, safflower oil-modified, sunflower oil-modified, walnut oil-modified, styrenated, vinyl-modified, urethane-modified, and silicone-modified alkyds; oil-modified urethanes; fats and oils such as soya oil, corn oil, sunflower oil, coconut oil, linseed oil, cottonseed oil, olive oil, tung oil, fish oil, peanut oil, and the like; oil-modified acrylics and the like; rosin and rosin esters; maleic-modified resins and the like; plasticizers, hydroxyl terminated polybutadiene resins and derivatives thereof; aromatic and aliphatic hydrocarbon resins such as, for example the Polybd and Norsolenen series of resins available from Sartomer Co, Exton, Pa. or the Petrorez and Pentrex brand polymers available from Lawter International Pleasant Prairie, Wis., and the Unirez brand resins available from Union Camp, Savannah, Ga.

Suitable solvents for stains and primers of the invention include but are not limited to aliphatic hydrocarbons, aromatic hydrocarbons, esters, ketones, ethers, parachlorobenzotrifluoride, and plasticizers.

Additives for the stains and primers of the invention include, but are not limited to, the additives described above; particularly, colorants, pigments, dyes, rheology modifiers, anti-settling agents, dispersants, antimar agents, UV absorbers, light stabilizers, antioxidants, metal complexation catalysts and crosslinkers, redox catalysts, flow and leveling agents, wetting agents, defoamers, catalysts, sunscreens, biocides, water repellants, waxes, and plasticizers.

Stains of the invention are capable of being used over bare wood or over washcoats and sealers and topcoats, without loss of finish clarity or appearance. The stains also exhibit desirable properties such as reduced grain raising and good water resistance.

An embodiment of the invention is directed to an aqueous adhesion promoter composition. The adhesion promoter composition includes an organic phase, an aqueous phase, and an emulsifier as described above. Typically, the organic continuous phase includes a solvent and a resin or additive including a chlorinated polyolefin. Use of a chlorinated polyolefin provides adhesion properties to the composition which are particularly useful in coating plastics such as thermoplastic polyolefins (TPOs), polyethylene and polyethylene composites such as decking materials and fences, polypropylene, polypropylene composites, wood plastic composites, and the like. However, a non-chlorinated polyolefin such as, for example AP 440-1 (Eastman Chemical Co., Kingsport, Tenn.) is also suitable.

Compositions and additives of the present invention have reduced volatile organic compound (VOC) content compared to conventional formulations, while maintaining solvent-like application and appearance properties. The reduction in VOC content depends on, e.g., the coating type and technology used therein. For example, the VOC content in the compositions, particularly for stains of the invention, can range from about 0 lbs/gal to about 4.0 lbs/gal of the formulation, preferably about 0.15 lbs/gal VOC to about 2.0 lbs/gal VOC.

The following examples are provided to further illustrate the present invention. It is to be understood, however, that these examples are for purposes of illustration only and are not intended as a definition of the limits of the invention.

### EXAMPLES

Examples 1-4 illustrate development of a resin or resin intermediate based on an oil modified polyurethane blended with the aminoester and/or a substituted alkanolamine, and subsequent low VOC deck stain development.

Example 1. Example of Resin and/or Intermediate

| Item | Wt/lbs |
|---|---|
| Solvent 150 | 8.9 |
| Paraffin Wax R2531 | 0.28 |
| Lubrizol 47550 AF | 0.84 |
| Irganox 1010 | 0.028 |
| Heated to 100-110° F. Mixed until dissolved, then added | |
| under agitation | |
| Foamtrol 110 | 0.42 |
| PolyFox PF3320 | 0.12 |
| Urotuff 19M50 | 5.65 |

Example 2. Example of Resin and/or
Intermediate and/or Formulation

| Item | Wt/lbs |
|---|---|
| Example 1 | 16.238 |
| Busan 1105 | 0.28 |
| Tinuvin 1130 | 0.07 |
| Michelman 433 | 0.14 |
| Hombitec RM401LP | 0.99 |

Mixed well

Example 3. Example of Intermediate
and/or Formulation and/or Stain

| Item | Wt/lbs |
|---|---|
| Example 2 | 17.718 |
| Added the following slowly under very | |
| good agitation and shear | |
| Water | 21.52 |

Example 4. Example of Intermediate
and/or Formulation and/or Stain

| Item | Wt/lbs |
|---|---|
| Example 3 | 39.23 |

Tinted with

| | |
|---|---|
| Tint-AYD AL600 | 0.42 |
| Tint-AYD AL499 | 0.70 |
| Calculated VOC | 31.3% VOC; 2.52 lbs VOC/gal |
| Viscosity, RVDVE, sp4, 100 rpm | 304 cps |
| Application and appearance | Excellent |

The composition of Example 1 is useful as a resin intermediate containing the surfactant, while the composition of Example 4 is useful as a low VOC deck stain.

The composition of Example 4 was compared to two commercial deck stains for water absorption; CWF-UV clear wood finish, manufactured by the Flood Company, Hudson, Ohio, and Cuprinol Redwood UV Sunblock deck and wood seal, manufactured by the Sherwin Williams Company, Cleveland, Ohio, by dipping followed by brushing pre-treated pine fence parts (from the same fence post). The entire 3.5 in×3.5 in part was coated, including the edges. 4.7 grams of the composition of Example 4 was applied to the wood part, while 4.90 grams and 4.53 grams of stain was applied to the wood parts with CWF-UV and Cuprinol stains respectively. A 4th wood part was left uncoated. After 5 days, the coated wood parts were submerged into a water bath for 1 hour. The bare wood absorbed 8.65% water. The CWF-UV and the Cuprinol Redwood stains absorbed 8% and 5.95% water respectively. The stain of Example 4 absorbed 4.9% water.

Example 5 details development of a stain with low viscosity and improved flow.

Example 5. Example of Deck Stain Formulation
With Low Viscosity and Improved Flow

| Item | Wt/grams |
|---|---|
| Solvesso 150 | 47 |
| Paraffin R2531 | 2 |
| Mineral Spirits 66/3 | 17 |
| Lubrizol 47550 AF | 6 |
| Irganox 1010 | 0.2 |
| Heated at 110° F. and mixed until dissolved | |
| Foamtrol 110 | 3 |
| PolyFox PF3320 | 0.85 |
| UROTUFF 19M50 | 40 |
| Michem Wax 433 | 1 |
| Hombitec RM401LP | 7 |
| Tinuvin 1130 | 0.5 |
| Busan 1105 | 2 |
| Mixed 10 to 15 min, then added with good | |
| agitation | |
| Water | 150 |
| Then added | |
| Tint-AYD AL600 | 3.0 |
| Tint-AYD AL499 | 5.0 |
| Solvesso 150 | 4.7 |
| BYK333 | 2 |
| Viscosity, #4 spindle, cps | 208 |

The stain of Example 5 was compared to commercial stains, CWF-UV and Cuprinol Redwood, by application onto 4 in×4 in pieces of picket fence parts. The entire part was coated with stain by dipping and brushing. The stains were allowed to air dry for 4 hours. The parts were then submerged into a water bath for 1 hour, along with an uncoated part. Table 1 details stain loading and water resistance results.

TABLE 1
Comparison of Example 5 Stain to Commercial
Stains for Early Water resistance

| | Wet Stain | % Water | |
|---|---|---|---|
| Stain | Loading | Absorption | Comments |
| Example 5 Stain | 4.6 grams | 10.26 | No visual change in |
| | | | wood dimensions |
| Bare Wood | N/A | 32.38 | Wood swells and cups |
| Cuprinol Redwood | 3.98 grams | 12.73 | Wood swells and cups |
| Commercial Stain | | | |
| CWF-UV Clear | 3.87 grams | 24.89 | Wood swells and cups |
| Wood Finish | | | |
| commercial Stain | | | |

The results of Table 1 show that the Example 5 stain penetrates the wood to a greater degree and result in improved early water resistance as compared to the commercial stains.

Examples 6 and 7 detail development of a natural deck stain.

Example 6. Example of Gilsonite Solution for
Incorporation in Low VOC Natural Deck Stain

| Item | Wt/grams |
|---|---|
| Solvesso 150 | 225 |
| Gilsonite ER125 | 75 |

Stirred until dissolved with some heating

Example 7. Example of Natural Deck Stain Formulation

| Item | Wt/grams |
|---|---|
| Solvesso 150 | 63 |
| Paraffin R2531 | 2 |
| Lubrizol 47550 AF | 6 |
| Irganox 1010 | 0.2 |
| Heated at 110° F. and mixed until dissolved | |
| Foamtrol 110 | 3 |
| PolyFox PF3320 | 0.85 |
| UROTUFF 19M50 | 40 |
| Michem Wax 433 | 1 |
| Hombitec RM401LP | 7 |
| Tinuvin 1130 | 0.5 |
| Busan 1105 | 2 |
| Mixed 10 to 15 min, then added with good | |
| agitation | |
| Water | 150 |
| Then added | |
| Tint-AYD AL499 | 1.59 |
| Tint-AYD AL505 | 0.61 |

Tinted to color with Example 6

The formulations of Example 7 was compared to a commercial natural deck stain, CWF-UV manufactured by the Flood Company, Hudson, Ohio. The stains were applied side-by-side to pressure treated pine by brush application. The stain of Example 6 showed greater penetration, and the stain appearances were comparable. However, the stain of Example 7 resulted in significant water beading, whereas the CWF-UV stain did not bead water substantially.

Examples 8 through 12 show reduced VOC emulsion compositions useful as wiping stain and glaze intermediates and stains and glazes.

Example 8. Example of Clear Water Based Glaze Utilizing
Aminoester and/or a substituted Alkanolamine for
Development of a 2.0 lbs/gal VOC Stain

| Item | % Weight |
|---|---|
| 2,2,4-Trimethyl-1,3-pentanediol | 3.82 |
| diisobutyrate | |
| Aromatic 150 | 15.55 |
| Mineral Spirits 66/3 | 5.03 |
| Oxsol 100 | 4.51 |
| Irganox 1010 | 0.07 |
| Lubrizol OS #47550AF, 1X.5 LT | 3.82 |
| Heated to 100-110° F., mixed until dissolved, then added | |
| Soy Salad Oil | 2.26 |
| Mixed, then added | |
| Aerosil R972 | 1.21 |
| Mixed 2-5 min, then added the following water slowly | |
| DI Water | 63.51 |
| Then added | |
| Cycat 296-9 | 0.33 |
| Total | 100.00 |
| Viscosity, RVDVE | 142 cps |
| pH | 8.37 |
| Theoretical VOC | 2.00 lbs/gal |

Example 9. Example of Intermediate for Water Based Glaze/Wiping
Stain Utilizing Aminoester and/or a Substituted Alkanolamine
for Development of a 2.0 lbs/gal VOC Stain

| Item | % Weight |
|---|---|
| Soy Salad Oil | 21.67 |
| Aromatic 150 | 41.00 |
| Irganox 1010 | 0.67 |
| Lubrizol OS#47550AF | 36.67 |
| Mixed until dissolved, with heating to | |
| 100-110° F. | |
| Viscosity, #2 Zahn Signature cup, 77° F. | 19-20 sec |

Example 10. Example of Utilizing Intermediate of Example
9 for Development of Water-based Clear Glaze/Wiping Stain

| Item | % Weight |
|---|---|
| Example 9 | 10.41 |
| Aerosil R972 | 1.21 |
| Next, added | |
| Aromatic 150 | 11.17 |
| 2,2,4-Trimethyl-1,3-pentanediol | 3.82 |
| diisobutyrate | |
| Mineral Spirits 66/3 | 5.03 |
| Oxsol 100 | 4.51 |
| Mixed thoroughly, then slowly added | |
| DI Water | 63.51 |
| Mixed 10 to 15 minutes, then added | |
| Cycat 296-9 | 0.33 |
| Total | 100.00 |
| Viscosity, RVDVE | 142 cps |
| Theoretical VOC | 2.00 lbs/gal |

Example 11. Example of Stain/Glaze Intermediate Base Incorporating
Aminoester and/or a substituted Alkanolamine for Development
of a 0.17 lbs VOC/lbs solids Stain

| Item | Wt % |
|---|---|
| Aromatic 150 | 14.45 |
| Irganox 1010 | 0.29 |
| Oxsol 100 | 43.35 |
| Lubrizol OS#47550AF, 1X.5 LT | 18.79 |
| Soy Salad Oil | 23.12 |
| Total | 100 |

Example 12. 0.17 lbs VOC/lbs solids Clear Stain

| Item | Wt % |
|---|---|
| Example 11 | 23.52 |
| DI Water | 50.99 |
| Nytal 300 | 10.20 |
| Oxsol 100 | 15.30 |
| Total | 100 |
| VOC, calculated | 0.17 lbs VOC/lbs solids |
| Viscosity, #2 Zahn, signature cup, 77° F. | 27 seconds |

Preparation of oak and cherry panels utilizing tinted stains of Examples 10 and 12 as wiping stain/glaze resulted in panels with excellent color and clarity. The stains also wiped well and were brush blend able.

The clear stain of Example 8 was tinted per Example 13 below, and compared to Examples 14-19 for wipe ability, clean up, and finish clarity.

Example 13. Tinted Low VOC Wiping
Stain/Glaze Based on Example 8

| Item | Wt/grams |
|---|---|
| Example 8 | 576.3 |
| Eagle Series 2000 WB1711 Burnt Umber | 75 |

Mixed

Example 14 (Comparative). Aqueous Stain/Glaze
Based on Joncryl 95 Vehicle

| Item | Wt/grams |
|---|---|
| Joncryl 95 | 99.95 |
| Ethylene Glycol dibutyl ether | 3 |
| Foamaster S | 3 |
| Eagle Series 2000 WB1711 Burnt Umber | 39.27 |
| Proxel GXL | 0.5 |
| Mixed well until well blended; Premix the following 4 | |
| items, then added under agitation | |
| Water | 150.4 |
| Propylene Glycol | 10.3 |
| Natrasol 250 HHBR PA | 1 |
| Ammonia | 0.34 |
| Total | 305 |
| Viscosity, #2Zahn, 78 F., sec | 16.2 |
| pH | 8.02 |

Example 15 (Comparative). Aqueous Stain/Glaze
Based on Chemphol 821-3660 Vehicle

| Item | Wt/grams |
|---|---|
| Chemphol 821-3660 | 99.95 |
| Surfynol 104 DPM | 0.5 |
| Propylene Glycol | 3 |
| Proxel GXL | 0.5 |
| Water | 50 |
| Eagle Series 2000 WB1711 Burnt Umber | 39.27 |
| Mixed well until well blended; Premixed the following 4 | |
| items, then added under agitation | |
| Water | 100 |
| Natrasol 250 HHBR PA | 1 |
| Ammonia | 0.34 |
| Propylene Glycol | 10.3 |
| Total | 304.86 |
| Viscosity, #2Zahn, 77 F., sec | 23 |
| pH | 7.85 |

Chemphol 821-3660 is an aqueous alkyd dispersion designed for wood stains and paints manufactured by Cook Composite Polymers, Kansas City, Mo.

Example 16. Table 2. Formulation B (Laponite RDS Thickener
Solution) disclosed in Int'l Publ. No. WO 01/35719,
p. 20 (incorporated by reference herein)

| Item | Wt/grams |
|---|---|
| Tap Water | 45 |
| Laponite RDS | 5 |

Mixed until clear and uniform

Example 17. Table 1. Formulation A (CMCAB Dispersion)
disclosed in Int'l Publ. No. WO 01/35719, p.
19-20 (incorporated by reference herein)

| Item | Wt/grams |
|---|---|
| Ethylene glycol butyl ether | 563.8 |
| CMCAB 641.2 | 241.6 |
| Mixed until dissolved, then added | |
| AMP-95 | 5.96 |
| DI Water | 1188.6 |

Example 18. Table 3. Formulation C (CMCAB Stain)
disclosed in Int'l Publ. No. WO 01/35719, p.
20-21 (incorporated by reference herein)

| Item | Wt/grams |
|---|---|
| DI Water | 133 |
| Example 16, Formulation B | 6.99 |
| SCT 275 Thickener | 5.56 |
| Mixed, then added | |
| Example 17, Formulation A | 65.1 |
| (CMCAB Dispersion) | |
| Mixed well, then added | |
| Eagle Series 2000 WB1711 Burnt Umber | 39.27 |
| Propylene Glycol | 50 |
| Total | 300 |
| Viscosity, #2Zahn, 77 F., sec | 17.38 |
| pH | 6.88 |

Example 19, below is a stain of the invention based on Tergitol™ XD emulsifier. The stain has low VOC, good working properties, reduced grain raising compared to conventional aqueous stains, and can be utilized directly to wood as well as over washcoat.

Example 19. Aqueous Stain/Glaze Based on
Tergitol ™ XD Surfactant

| Item | Wt/grams |
|---|---|
| 2,2,4-Trimethyl-1,3-pentanediol | 10 |
| diisobutyrate (TXIB) | |
| Solvesso 150 | 40 |
| Mineral Spirits 66/3 (Varsol) | 15 |
| Parachlorobenzotrifluoride (Oxsol 100) | 10 |
| Tergitol XD | 10 |
| Irganox 1010 | 0.2 |
| Heated to 100-110° F. to dissolve, then added under agitation | |
| Aerosil R972 | 3 |
| Soya Oil | 6 |
| Heated the following water to 100° F. and added slowly | |
| with good agitation (1000-1500 rpm) | |
| DI water | 165 |
| Mixed 10-15 minutes, then added | |
| Eagle Series 2000 WB1711 Burnt Umber | 34 |
| DI water | 7 |
| Total | 300.2 |
| Viscosity, #2 Zahn, 77° F., sec | 22.3 |
| pH | 7.85 |

The compositions of Examples 13, 14, 15, 18, and 19 were evaluated in several different ways including panel development. Tables 2, 3, and 4 below compare various test results of the stains.

TABLE 2
Evaluation of Stains of Examples 13, 14, 15, 18, and 19

| | Stain | | | | |
|---|---|---|---|---|---|
| Test/Evaluation | Example 13 | Example 18 | Example 14 | Example 19 | Example 15 |
| Wet Edge (0.5 g on | 7 min, 5 | 6 min, 10 | 4 min, 23 | 10 minutes | 6 min, 30 |
| 4X6 in glass plate) | seconds | seconds | seconds | | seconds |
| Wet Edge (7 drops | 10 minutes | 10 minutes | 5 min, 15 | 7 min, 12 | 4 min, 8 |
| on 4X6 glass plate | | | seconds | seconds | seconds |
| and work in 4 in | | | | | |
| square area) | | | | | |
| Wet Edge (7 drops | 2 min, 30 | 3 min, 3 sec; | 1 min, 39 | 2 min; | 2 min, 29 |
| on 1.5X6 inch | seconds; | disappeared | seconds; | became | seconds; |
| ramin wood strip) | disappears | into wood; | became | sticky; very | became |
| | into wood - | somewhat | sticky; very | mottled | sticky; very |
| | smooth | mottled | mottled | | mottled |
| Grain raising on | 2 | 2 | 5 | 3 | 4 |
| ramin wood (spray | | | | | |
| and wipe) | | | | | |
| (1 = good; 5 = bad) | | | | | |
| Grain raising on | 2 | 3 | 5 | 3 | 4 |
| oak wood (spray | | | | | |
| and wipe) | | | | | |
| (1 = good; 5 = bad) | | | | | |
| Washcoat attack | 1 | 4 - sticky | 4 - sticky | 1 | 4 - sticky |
| (sprayed 12% | | | | | |
| nitrocellulose | | | | | |
| washcoat on ash | | | | | |
| wood; dried for 30 | | | | | |
| min; sprayed | | | | | |
| glaze/stain, let set | | | | | |
| 2 min, wiped clean) | | | | | |
| (1 = no effect; 5 = bad) | | | | | |

TABLE 3
Evaluation of Stains of Examples 13, 14, 15, 18, and 19 - Cherry Panels
with toner, with and without washcoat; Acid cure sealer and topcoat
Sprayed wet coat wiping stain; flashed 5 min, wiped, brushed, and
hi-lited. Air Dried 1 hr, then 5 min @130° F.

| | Panel | | | | | | | | | |
|---|---|---|---|---|---|---|---|---|---|---|
| | 1 | | 2 | | 3 | | 4 | | 5 | |
| Example | 13 | 14 | 13 | 18 | 13 | 19 | 13 | 14 | 13 | 15 |
| With Washcoat | N/A | | | | | | | | | |
| Crosshatch | | | 4B | 4B | 3B | 3B-4B | 4B | 4B-5B | 3B | 3B |
| adhesion | | | | | | | | | | |
| Nickel scrape | | | 6 | 9 | 7 | 9-10 | 5 | 8 | 5 | 6 |
| adhesion (1 = | | | | | | | | | | |
| worse; | | | | | | | | | | |
| 10 = best) | | | | | | | | | | |
| Wiping | | | Wiped | Wiped | Wiped | Wiped | Wiped | Wiped | Wiped | Wiped |
| | | | clean | clean | clean | clean | clean | clean | clean | clean |
| Color/clarity | | | Clean | Clean, but | Clean | Clean and | Clean | Clean and | Clean | Sl muddy |
| | | | and | not quite as | and | bright; sl | and | bright; v sl | and | and sl |
| | | | bright | clean and | bright | more grainy | bright | graininess | bright | grainy |
| | | | | bright; sl | | appearance | | | | |
| | | | | more grainy | | | | | | |
| | | | | appearance | | | | | | |

Without Wash coat

| | | | | | | | | | | |
|---|---|---|---|---|---|---|---|---|---|---|
| Crosshatch | 4B | 4B | 4B | 4B | 3B | 4B | 4B | 4B | 3B | 3B |
| adhesion | | | | | | | | | | |
| Nickel scrape | 6 | 7 | 6 | 8 | 7 | 8 | 5 | 9 | 5 | 6 |
| adhesion | | | | | | | | | | |
| Wiping | wiped | Wiped | Wiped | Wiped | Wiped | Wiped | Wiped | Wiped | Wiped | Wiped |
| | clean | clean | clean | clean | clean | clean | clean | clean | clean | clean |
| Color/clarity | Clean | Clean, | Clean | Clean, but | Clean | Clean and | Clean | Clean and | Clean | Sl muddy |
| | and | sl | and | not quite as | and | bright; sl | and | bright; v sl | and | and sl |
| | bright | more | bright | clean and | bright | more grainy | bright | graininess | bright | grainy |
| | | muddy | | bright; sl | | appearance | | | | |
| | | | | more grainy | | | | | | |
| | | | | appearance | | | | | | |

TABLE 4
Evaluation of Stains of Examples 13, 14, 15, 18, and 19 - Cherry Panels
with toner, with and without washcoat; Acid cure sealer and topcoat
Sprayed wet coat wiping stain/glaze; flashed 5 min, break
down, set 10 min, wiped clean, cure @130° F.

| | Panel | | | | | | | | | |
|---|---|---|---|---|---|---|---|---|---|---|
| | 6 | | 7 | | 8 | | 9 | | 10 | |
| Example | 13 | 14 | 13 | 18 | 13 | 15 | 13 | 19 | 13 | 15 |

With Washcoat

| | | | | | | | | | | |
|---|---|---|---|---|---|---|---|---|---|---|
| Crosshatch | 3B | 3B | 3B | 4B-5B | 3B | 4B-5B | 4B | 5B | 3B | 4B |
| adhesion | | | | | | | | | | |
| Nickel scrape | 5 | 9-10 | 6 | 10 | 6 | 7-8 | 5 | 8-9 | 6 | 6 |
| adhesion | | | | | | | | | | |
| Wiping | Excellent | V. | Excellent | Streaky; | excellent | Did not | Wiped | Wiped | Wiped | V. |
| | | Streaky; | | did not | | clean up, | clean | clean | clean | Streaky; |
| | | did not | | clean up | | v streaky | | | | did not |
| | | clean up | | | | | | | | clean up |
| Color/clarity | Clean | Muddy, | Clean | Muddy, | Clean | Muddy, | Clean | Clean | Clean | Muddy, |
| | and | removed | and | removed | and | removed | and | and | and | topcoat |
| | bright | WC; | bright | WC; | bright | WC | bright | bright | bright | lifts |
| | | topcoat | | | | | | | | |
| | | lifts | | | | | | | | |

Without Wash coat

| | | | | | | | | | | |
|---|---|---|---|---|---|---|---|---|---|---|
| Crosshatch | 3B | 4B | 3B | 4B-5B | 3B | 4B | 2B-3B | 2B-3B | 3B | 3B |
| adhesion | | | | | | | | | | |
| Nickel scrape | 4 | 9 | 4 | 9 | 5 | 9 | 2 | 5-6 | 5 | 8 |
| adhesion | | | | | | | | | | |
| Wiping | wiped | Fair | Excellent | Sl | Wiped | Did not | Wiped | Wiped | Wiped | V. |
| | clean | clean | | streaky | clean | clean up; | clean | clean | clean | Streaky; |
| | | up | | | | v streaky | | | | did not |
| | | | | | | | | | | clean up |
| Color/clarity | Clean | Muddy, | Clean | muddy | Clean | V muddy | Clean | Clean and | Clean | V muddy |
| | and | removed | and | | and | and | and | bright; | and | and |
| | bright | WC; | bright | | bright | topcoat | bright | v sl | bright | grainy |
| | | topcoat | | | | lifts | | graininess | | |
| | | lifts | | | | | | | | |

Example 20, below illustrates a dispersion of water into a fluorocarbon modified acrylic polymer. The dispersion results in a reduced VOC fluorocarbon modified acrylic polymer useful for improving hydrophobicity and water and oil repellency of various substrates such as wood, composites, textiles, paper, and the like, and any substrate wherewith such improvements are useful.

Example 20. Aqueous Dispersion of Water
into a PerFluorinated Acrylic Polymer

| Item | Wt/grams |
|---|---|
| Aromatic 150 | 23.84 |
| Lubrizol OS#47550AF | 3.02 |
| Mixed until dissolved, then added | |
| Flexipel S-22 WS | 20.27 |
| Mixed well, then added under medium agitation | |
| Tap water | 57.00 |

Product goes together very well; Very Foamy

The dispersion of Example 20 was applied to a Leneta chart with a 3 mil bird bar. A smooth uniform wet film resulted. After drying, the film was somewhat foamy, hazy, but not grainy, and slightly tacky. Application of water drops on the film resulted in significant water beading and splitting of the water drop into many drops. After the sample of Example 20 had sat for 13 days, the sample showed some separation, but stirred back in very easily and had minimal air present. A second draw down was made on a Leneta chart. A smooth white wet film resulted. The draw down was allowed to air dry overnight. A smooth, hazy, and slightly yellow film resulted that beads water. This latter drawdown was placed into an 80° C. oven for 25 minutes. A clear, glossy, slightly yellow, and slightly tacky film resulted. The oven-aged sample beaded water significantly better than the non-oven-aged sample.

Illustrative applications for this technology include exterior siding that is water resistant, textiles and nonwovens, house paint that resists water and stains, decks and porches, rain wear and umbrellas, and shoes.

### Example 21

### Water-in-Oil Dispersions Containing Waxes

The inventive dispersions incorporating a wax may be used in such applications as, but not limited to, edge seal coatings, wax additives, lubricants, and wax coatings. The wax dispersion formulation is shown below in Table 5 (see Example 20 for the base formula).

TABLE 5
Addition of Wax to Water in Oil Dispersion

| Item (g) | Weight (g) | Weight (%) |
|---|---|---|
| Solvesso 150 | 31.46 | 11.44 |
| Mineral Spirits | 31.46 | 11.44 |
| Paraffin Wax R2531 | 53.54 | 19.47 |
| Lubrizol OS #47550AF | 7.98 | 2.90 |

Mixed with heat to dissolve, then added with medium agitation:

| | | |
|---|---|---|
| Distilled Water | 150.56 | 54.74 |
| TOTAL | 275.00 | 100.00 |

| % NVM | 22.37 |
|---|---|
| % Wax | 19.47 |
| Viscosity, Brookfield RV DV-E, | 1100 cps @ 11.0% T |
| sp#6, 100 rpm, @ 78 F. | |

Next a resin was added as shown below in Table 6.

TABLE 6
Addition of Resin

| Item | Weight (g) |
|---|---|
| Composition of Table 5 | 100.00 |
| UROTUF F-19-M50 | 10.00 |
| TOTAL | 110.00 |
| NVM | 24.88% |
| Wax | 17.70% |

A competitive wax coating, shown below in Table 7, was made to compare with the properties of the coating of Table 6.

TABLE 7
Competitive Wax Coating

| Item (g) | Weight (g) |
|---|---|
| Slip Ayd SL 145E | 21.64 |
| 40% EB-49 | 6.25 |
| Tap Water | 27.12 |
| TOTAL | 55.01 |
| NVM | 22.25% |
| Wax | 17.70% |

The samples were evaluated for film formation and appearance by a 1.5 mil DD on Leneta Form 7B. The results are detailed below in Table 8.

TABLE 8
Comparison of Coatings of Tables 6 and
7 - 1.5 mil DD on Leneta Form 7B

| Cure Schedule | Coating of Table 6 | Coating of Table 7 |
|---|---|---|
| Air dry | did not form a film, has | formed a film, puddled |
| | large wax particles | in center and right edge |
| Flash completely, | formed a film, puddled | formed a film, puddled |
| 20′@80° C., cool | on right edge | in center and top edge |
| overnight | | |

Two 20 RDS DDs on masonite board were performed for each sample. One sample air dried overnight and the other air dried to flash, put in an 80° C. oven for 20 minutes, and then cooled overnight. These results are detailed below in Table 9.

TABLE 9
Comparison of Coatings of Tables 6
and 7 - 20RDS DD on Masonite Board

| Cure Schedule | Coating of Table 6 | Coating of Table 7 |
|---|---|---|
| Air dried | did not form a film, has | formed a film, splotchy, |
| | large wax particles | wax flowed to the top |
| Flashed completely, | formed a film, smooth | formed a film, splotchy, |
| 20′@80° C., cooled | and even appearance | wax flowed to the top |
| overnight | | |

Next, to keep the wax in the dispersion, the formulation of Table 5 was remade keeping the batch warm while mixing. This formula is shown below in Table 10.

TABLE 10
Formulation

| Item | Weight (g) |
|---|---|
| Solvesso 150 | 15.73 |
| Mineral Spirits 66/3 | 15.73 |
| Paraffin Wax R2531 | 26.77 |
| Lubrizol OS#47550AF | 3.99 |
| Mixed with heat to dissolve, continued heating and | |
| mixing then added: | |
| DI Water | 75.28 |
| TOTAL | 137.50 |

Next a resin was added to the formulation of Table 10, as shown below in Table 11.

TABLE 11
Formulation

| Item | Weight (g) |
|---|---|
| Formul. of Table 10 | 50.00 |
| UROTUF F-19-M-50 | 5.00 |
| TOTAL | 55.00 |
| NVM | 24.88% |
| Wax | 17.70% |

A 20 RDS DD was performed on the masonite board and then put immediately in the oven for 20 minutes @ 80° C. It formed a film, and although it appeared splotchy it felt smooth. A 1.5 mil DD was performed on Leneta Form7B and was allowed to air dry overnight. This DD did not form a film and had large wax particles in it. It appears that the sample remains uniform when heated, but when it cools the wax particles come out of the dispersion.

All of the samples were tested for water resistance by performing the Cobb Water Soak Test on the drawdowns made on masonite board. The steps to the test are: 1) Drill ½ in. hole in masonite board; 2) Use 180 grit sandpaper to clean holes and sand edges around holes; 3) Weigh board; 4) Place gasket next to coated side of board; 5) Tighten nuts with 9/16 in. wrench; 6) Pour 100 mL in circle and cover, 7) After 4 hours remove water from board and blot dry; and 8) Reweigh board.

The results of the tests are detailed below in Table 12.

TABLE 12
Cobb Water Soak Test Results (DD on Masonite Board)

| Sample | | Wt (g) | Wt (g) | After − | % Wt |
|---|---|---|---|---|---|
| Coating | DD Cure Schedule | before | after | Before (g) | increase |
| Table 7 | flash, 20′@80° C., | 254.31 | 255.48 | 1.17 | 0.46 |
| | cool O.N. | | | | |
| Table 6 | flash, 20′@80° C., | 258.80 | 259.98 | 1.18 | 0.46 |
| | cool O.N. | | | | |
| Blank | None | 254.15 | 254.95 | 0.80 | 0.32 |
| Table 11 | 20′@80° C., | 259.14 | 259.98 | 0.84 | 0.32 |
| | cool O.N. | | | | |
| Table 6 | Air dry overnight | 266.02 | 266.76 | 0.74 | 0.28 |
| Blank | None | 252.62 | 253.44 | 0.82 | 0.32 |
| Table 7 | Air dry overnight | 262.34 | 263.14 | 0.80 | 0.30 |
| Blank | 20′@80° C., | 254.36 | 256.24 | 1.88 | 0.73 |
| | cool O.N. | | | | |

Water resistance was evaluated again by a 20RDS DD on a 7×7 MDF panel. The drawdowns were placed in an 80° C. oven for 20 minutes and then cooled overnight. The same procedure was followed as stated above, except the test was left on for 24 hours. The results are shown below in Table 13.

TABLE 13
Cobb Water Soak Test Results (DD on MDF Panel)

| | Wt (g) | Wt (g) | After − | % Wt |
|---|---|---|---|---|
| Sample Coating | before | after | Before (g) | increase |
| Blank | 304.76 | 314.75 | 9.99 | 3.28 |
| Table 11 | 296.64 | 306.11 | 9.47 | 3.19 |
| Example 20 | 345.39 | 348.60 | 3.21 | 0.93 |
| Table 7 | 324.96 | 329.61 | 4.65 | 1.43 |

The wax dispersion must be kept warm while mixing for the wax particles to stay in solution. Wax dispersions of Tables 6 and 11 performed equally to the SlipAyd formulation, Table 7 in terms of water resistance on the masonite board. However when the water soak test was applied to the MDF panel for 24 hours, the coating of Table 11 absorbed more water than the coating of Table 7.

### Example 22

### Water-in-Oil Dispersions Containing Silicones

The inventive dispersions incorporating silicones may be used in such applications as, but not limited to personal care items, car and furniture polishes, tire wet products, release agents, flow and leveling agents, antifoams, and concrete treatments.

A silicone fluid was added to the water-in-oil dispersion of the base formula of Example 20 as shown below in Table 14.

TABLE 14
Addition of Silicone to Water in Oil Dispersion

| Item | Weight (g) | Weight (%) |
|---|---|---|
| Mineral Spirits 66/3 | 17.16 | 11.44 |
| SF-69 | 46.38 | 30.92 |
| Lubrizol OS#47550AF | 4.35 | 2.90 |
| Mixed well, then added with medium agitation | | |
| Distilled Water | 82.11 | 54.74 |
| TOTAL | 150.00 | 100.00 |

A liquid layer formed on top of the sample, which appeared to have coagulated. Mineral spirits was replaced with xylene, to see if the SF-69 would be soluble in it. This formula is shown below in Table 15.

TABLE 15
Dispersion of Table 14 with Xylene in place of Mineral Spirits

| Item | Weight (g) | Weight (%) |
|---|---|---|
| Xylene | 17.16 | 11.44 |
| SF-69 | 46.38 | 30.92 |
| Lubrizol OS#47550AF | 4.35 | 2.90 |
| Mixed well, then added with medium agitation | | |
| Distilled Water | 82.11 | 54.74 |
| TOTAL | 150.00 | 100.00 |

This sample also coagulated and separated. Approximately 1.03 g more of OS#47550AF was added to try to make the sample smooth and uniform. However, the sample remained coagulated. Next, the amount of silicone was cut in half and replaced with xylene. This formulation is shown below in Table 16.

TABLE 16
Formulation with Reduced Silicone and Xylene Added

| Item | Weight (g) | Weight (%) |
|---|---|---|
| Mineral Spirits | 17.16 | 14.00 |
| Xylene | 23.19 | 18.91 |
| SF-69 | 23.19 | 18.91 |
| Lubrizol OS#47550AF | 4.35 | 3.55 |
| Mixed well, then added with medium agitation | | |
| Distilled Water | 54.74 | 44.63 |
| TOTAL | 122.63 | 100.00 |

This formula had little separation and no coagulation. Next, the above formula was made with DC200 in place of SF-69 as shown in Table 17.

TABLE 17
Formulation with DC200

| Item | Weight (g) | Weight (%) |
|---|---|---|
| Mineral Spirits | 17.16 | 14.00 |
| Xylene | 23.19 | 18.91 |
| DC 200 | 23.19 | 18.91 |
| Lubrizol OS#47550AF | 4.35 | 3.55 |
| Mixed well, then added with medium agitation | | |
| Distilled Water | 54.74 | 44.63 |
| TOTAL | 122.63 | 100.00 |

The two samples of Tables 16 and 17 were evaluated for polishing. Both samples polished the polishing panel, beaded water, and had slight improvement in mar resistance in comparison to the product on the polishing panel. Both samples were approximately equal in appearance, although it seemed that the Table 16 composition took more effort to rub in than the Table 17 composition.

Next, the samples were evaluated as defoamers in a water based acrylic dispersion coating based on AC 2538 polymer from Alberdingk Boley, Greensboro, N.C., with FC-129 added for foaming. That formulation is described in Table 18. The samples were agitated @1200 rpm for 5 minutes then poured into a tared 100 mL cylinder. The foam height of each sample was measured initially and after 10 minutes, along with the portion of the sample without foam. The results are shown below in Table 19.

TABLE 18
Aqueous Acrylic Coating for Evaluation of Defoaming Efficacy

| Item | Wt/grams |
|---|---|
| Tap water | 723.10 |
| Diethylene glycol butyl ether | 29.58 |
| AC 2538 polymer | 1238.18 |
| RM2020 | 14.76 |

TABLE 19
Evaluation of Silicone Dispersions as Defoamers

| Item | Weight (g) | | |
|---|---|---|---|
| Table 18 Coating | 45.00 | 45.00 | 45.00 |
| FC-129 | 0.27 | 0.26 | 0.26 |
| Formul. of Table 16 | — | 0.20 | — |
| Formul. of Table 17 | — | — | 0.20 |
| Total Ht coating and foam | 139 mm | 133 mm | 125 mm |
| after 10′ | | | |
| Bottom liquid Ht (part w/o | 22 mm | 46 mm | 50 mm |
| foam) after 10′ | | | |
| Foam Reduction (or | 16 | 35 | 40 |
| deareation) (%) | | | |

Silicones can be added to the water-in-oil dispersion. Although there is some separation, the samples mix back together easily. Both samples give good results for polishing, mar resistance, and defoaming.

### Example 23

### Water-in-Oil Dispersions Containing Chlorinated Polymers

The inventive dispersions incorporating chlorinated polymers may be used in such applications as, but not limited to adhesion promoter coatings for plastic.

Chlorinated Polyolefin (CP) 343-4 was added to the water-in-oil dispersion of the base formula of Example 20 as shown below in Table 20.

TABLE 20
Addition of Chlorinated Polyolefin to Water in Oil Dispersion

| Item | Weight (g) | Weight (%) |
|---|---|---|
| Solvesso 100 | 34.34 | 22.89 |
| CP 343-4 | 29.20 | 19.47 |
| Mixed until dissolved, then added: | | |
| Lubrizol OS#47550AF | 4.35 | 2.90 |
| Mixed and added with medium agitation: | | |
| Distilled Water | 82.11 | 54.74 |
| TOTAL | 150.00 | 100.00 |

| | |
|---|---|
| Viscosity, Brookfield RV-DVE, | 420 cps @ 4.2% T |
| sp#6, 100 rpm, @78° F. | |

Next a polyurethane resin was added to the formulation of Table 19 as shown below in Table 21.

TABLE 21
Addition of Resin

| Item | Weight (g) |
|---|---|
| Formulation of Table 20 | 75.00 |
| UROTUF F19-M-50 | 7.50 |
| TOTAL | 82.50 |

A 1.5 mil DD of each sample was made on Leneta Form 7B and allowed to air dry overnight to evaluate appearance. The formulation of Table 20 formed a yellowish film that cratered. The formulation of Table 21 formed a smooth yellowish film.

Next the samples were sprayed on TPO Engineered Test Plaques and cured by 30′ flash, 10′ @ 66° C., then 1 hr cool. The samples had not flashed completely before they were placed in the oven; this caused the formulation of Table 21 to blister. The samples were re-sprayed on TPO and flashed for 2 hours, 1 hr @66° C., and cooled overnight.

A 2K urethane coating was made to apply to the coated TPO plaques and a blank TPO plaque. This formulation is shown below in Table 22.

TABLE 22
2K Urethane Coating

| Item | Volume (oz.) |
|---|---|
| NAPA Acrylic Urethane Enamel | 3 |
| MSU 475 Hardener | 1 |

After the plaques were sprayed, they air-dried for 7 days and then were evaluated for adhesion using ASTM D3359—tape cross hatch adhesion test. The results are detailed below in Table 23.

TABLE 23
Evaluation of Adhesion on TPO Plaques

| Sample | Results |
|---|---|
| Formul. of Table 19 | 0% removed, 5B |
| Formul. of Table 20 | 0% removed, 5B |
| Blank | 0% removed, 5B, but 100% |
| | removed on edge of panel |

Next, the plaques were placed in a water bath in which the bottom half of the plaques soaked for 10 days. The plaques were then removed, blotted dry, allowed to recover for 1 hour, and then evaluated for adhesion and blistering. These results are detailed below in Table 24.

TABLE 24
Evaluation of Adhesion on Water Soaked TPO Plaques

| Sample | Water Soak Results | Non-soaked Results |
|---|---|---|
| Formul. of Table 20 | orange peel | orange peel |
| | 0% removed, 5B | 0% removed, 5B |
| Formul. of Table 21 | 0% removed, 5B | 0% removed, 5B |
| Blank | blisters | slight blisters |
| | failed on cutting, 0B | 0% removed, 5B |

Chlorinated polyolefin can be added to the water-in-oil dispersion, giving good adhesion results.

Further, it is believed that the addition of the chlorinated polyolefin to the system improves the ability to disperse and maintain dispersion stability. Thus, a UV curable dispersion has been made that is coated onto TPO, cured, and can be subsequently coated and have excellent adhesion. Example 24, below illustrates this property.

### Example 24

### Dispersions for Coating TPO Plastic, Including UV Curable Dispersions

TABLE 25
UV Monomer-Photoinitiator Blend

| Item | Wt/grams |
|---|---|
| Sartomer SR344 | 2478.0 |
| TMPTA-N | 1006.69 |
| Irgacure 184 | 329.11 |
| Tego Wet 500 | 29.03 |

TABLE 26
UV Coating

| Item | Wt/grams |
|---|---|
| Formulation of Table 25 | 76.42 |
| Ebecryl 3212 epoxy acrylate oligomer | 123.58 |

TABLE 27
Emulsified Water Utilizing Chlorinated Polyolefin

| Item | Wt/grams |
|---|---|
| Solvesso 100 | 57.23 |
| Chlorinated Polyolefin CP 343-3 | 48.67 |
| Mixed until dissolved, then added | |
| Lubrizol OS#47550AF | 7.38 |
| Mixed and added the following with medium agitation | |
| DI water | 136.85 |

TABLE 28
Formulations Utilizing Emulsified Water

Formulation, Wt/grams

| Item | A | B |
|---|---|---|
| Formul. of Table 27 | 75 | 75 |
| Urotuf F-19-M-50 | 7.50 | |
| Formul. of Table 26 | | 7.5 |
| Result | Smooth dispersion | Smooth dispersion |

Formulation B was spray applied to a piece of TPO that had been wiped with isopropanol. The coated TPO plaque was allowed to air flash for 20 minutes, and then was cured for 25 minutes in an oven set at 49° C. with its doors open. The coated and oven cured plaque was then cured by UV exposure (American Ultraviolet curing unit, Hg lamp housed in an elliptical reflector, at 300 watts; 1 pass, at 30 feet per minute, resulting in 304 mj/m², 0.674 w/cm² cure energy UVA). The UV cured panel was then coated with a Napa 2K acrylic urethane refinish topcoat. The panel was allowed to sit 18 days at room temperature and then the adhesion evaluated by ASTM 3359—results—5B (Excellent). The coated and cured plaque was then exposed to a water bath for 10 days. The plaque was removed and blotted dry. There was no sign of blistering. The plaque was allowed to recover for 1 hour and the adhesion re-evaluated by ASTM 3359 on the water exposed area—result—5B (Excellent).

It is also noted that the water exposed and wiped panel has slight less gloss, slight textured surface and appears to be slight less white (i.e., more yellow).

### Example 25

### Dual Emulsions

A dual emulsion has been prepared, utilizing a chlorinated polyolefin as a hydrophobic moiety and Alberdingk H595 (Alberdingk Boley, Inc., Greensboro, N.C.), an aqueous acrylate-styrene copolymer dispersion, instead of water. The formulation is described below.

TABLE 29
Formulation Incorporating Alberdingk H595 Aqueous Polymer
In Place of Water in Formulation of Table 26

| Item | Wt/grams |
|---|---|
| Solvesso 100 | 57.23 |
| CP-343-3 | 48.73 |

Mixed until dissolved, then added

| | |
|---|---|
| Lubrizol OS#47550AF | 7.54 |

Mixed until dissolved, then added

| | |
|---|---|
| Alberdingk H595 | 136.90 |

Product goes together fine, but thickened tremendously

| | |
|---|---|
| Mineral Spirits 66/3 | 40.20 |

Addition of mineral spirits 66/3 lowered viscosity very significantly
and product looks very uniform. Product remained uniform for greater
than 1 month

| | |
|---|---|
| Made 6 mil DD on form 7B paper, air | Film is clear but has a yellow |
| dry over weekend | tint over white portion. Film |
| | is slightly tacky and soft |
| Made 6 mil DD on plate glass, air dry | Film has a yellow cast, but |
| over weekend | clear. Film can be stripped |
| | from the glass |

The formulation of Table 29 was applied to treated pine decking. The product appears to brush well, and has a good appearance. The formulation was tinted with alkyd tint colors from Elementis Specialties (Tint-AYD AL series). The product results in a very clear colored finish, but did not brush as well as expected.

### Example 26

### Aqueous Deck Stain Formulation

Example 26 illustrates an aqueous deck stain formulation using ethanoldiethonium polyisobutenyl triethylaminosuccinate as an emulsifier.

Example 26. Preparation of an Aqueous Deck Stain
Formulation Containing Chemccinate 5603

| Item | |
|---|---|
| Solvesso 150 | 16 |
| Paraffin Wax R2531 | 2.7 |
| Chemron Chemccinate 5603 | 8.2 |
| Irganox 1010 | 0.27 |
| Heated to 100-110° F. | |
| Foamtrol 110 | 4.1 |
| PolyFox PF3320 | 1.15 |
| Urotuff 19M50 | 54.8 |
| Michem Wax 433 | 1.36 |
| Hombitec RM401LP | 9.6 |
| Tinuvin CGL1130 | 0.68 |
| Busan 1105 | 2.7 |
| Solvesso 150 | 48.4 |
| Mineral Spirits | 23.36 |
| Added slowly under agitation | |
| Water | 206.25 |
| Tinted with | |
| Tint-AYD AL600 | 4.1 |
| Tint-AYD AL499 | 6.84 |
| Premixed the next two items and added | |
| Solvesso 150 | 6.44 |
| BYK 333 | 2.75 |
| Appearance | Smooth, uniform (equal) |
| Viscosity, #2Zahn, signature cup, sec | 27.3, 27.4 |
| Color | Reddish orange (equal) |
| Brushability | Good (equal) |
| Water bead test | Good (equal) |

The following examples show polyols useful in coatings of the invention.

### Example 27

### Hydroxy-Functional Acrylic Resin Coating Formulation

To a mixing vessel equipped with a cowles blade was charged about 11 grams of methyl n-amyl ketone, about 34 grams of Solvesso 150, about 40 grams of a hydroxyl functional acrylic resin having a molecular weight of 20,000, acid number of 10, and hydroxyl equivalent weight of 650, and about 6 grams of Lubrizol OS#47550 AF. This mixture was mixed well. Then about 110 grams of deionized water was added to the mixture with medium agitation. A water-in-acrylic resin emulsion was obtained having a viscosity (78° F., Brookfield RV DVE, sp6, 100 rpm) of about 2320 cps.

### Example 28

### Unsaturated Polyester Resin Coating Formulation

To a mixing vessel equipped with a cowles blade was charged about 15 grams of methyl n-amyl ketone, about 41 grams of Solvesso 150, about 30 grams of an unsaturated polyester resin having a molecular weight of about 950, an acid number of about 25, and an iodine number of about 70, and about 6 grams of Lubrizol OS#47550 AF.

This mixture was mixed well. Then about 110 grams of deionized water was added to the mixture with medium agitation. A water-in-modified unsaturated polyester resin emulsion was obtained having a viscosity (78° F., Brookfield RV DVE, sp6, 100 rpm) of about 470 cps.

### Example 29

### Caprolactone Polyol Formulation

A 60% solids solution of CAPA2047A Caprolactone polyol was made by charging 20 grams methyl propyl ketone, 20 grams xylene, and 60 grams CAPA 2047A caprolactone polyol (Solvay Caprolactones, Warrington, England) to a mixing vessel equipped with a cowles dissolver and mixing until solution was obtained.

### Example 30

### Aqueous Caprolactone-Based Polyol Coating Formulation

To a mixing vessel equipped with a cowles blade was charged about 11 grams of methyl n-amyl ketone, about 34 grams of Solvesso 150, about 40 grams of the formulation of Example 29, and about 6 grams of Lubrizol OS#47550 AF. This mixture was mixed well. Then about 110 grams of deionized water was added to the mixture with medium agitation. A water-in-caprolactone-based polyol resin emulsion was obtained having a viscosity (78° F., Brookfield RV DVE, sp6, 100 rpm) of about 510 cps.

### Example 31

### Polybutadiene Polyol Coating Formulation

To a mixing vessel equipped with a cowles blade was charged about 17 grams of methyl n-amyl ketone, about 45 grams of Solvesso 150, about 23 grams Polybd R-20LM (Sartomer Company, Exton, Pa.), and about 6 grams of Lubrizol OS#47550 AF. This mixture was mixed well. Then about 110 grams of deionized water was added to the mixture with medium agitation. A water-in-polybutadiene polyol resin emulsion was obtained having a viscosity (78° F., Brookfield RV DVE, sp6, 100 rpm) of about 1140 cps.

The formulations of Examples 27, 28, 30 and 31 all went together well forming a smooth dispersion. After several weeks, the samples showed separation. All samples were crosslinked with polyisocyanates and evaluated for chemical resistance after 7 day aging of a 1.5 mil wet film drawdown. The following table details the crosslinked samples and the results obtained.

TABLE 30
Detail of Crosslinked Samples and Results Obtained

| | Example | | | | | | | |
|---|---|---|---|---|---|---|---|---|
| Item | 27 | 27 | 28 | 28 | 30 | 30 | 31 | 31 |
| Example 27(g) | 20 | 20 | | | | | | |
| Example 28(g) | | | 20 | 20 | | | | |
| Example 30(g) | | | | | 20 | 20 | | |
| Example 31(g) | | | | | | | 20 | 20 |
| Desmodur | 3.5 | | 3.5 | | 3.5 | | 3.5 | |
| N3300(g) | | | | | | | | |
| Bayhydur VP | | 3.5 | | 3.5 | | 3.5 | | 3.5 |
| LS 2336(g) | | | | | | | | |
| | | | | | Jell | Jell | Jell | Jell |
| Red marker | 0.67 | 2.71 | 4.81 | 1.29 | N/A | N/A | N/A | N/A |
| resistance Δa | | | | | | | | |
| 1 hr mustard | 2.0 | 9.28 | 13.59 | 23.60 | N/A | N/A | N/A | N/A |
| stain resistance | | | | | | | | |
| Δb | | | | | | | | |
| 24 hr detergent | No effect | Hazy | Sticky | sticky | N/A | N/A | N/A | N/A |
| resistance | | | | | | | | |
| 24 hour ethanol | No visual | Hazy | Sticky | Hazy | N/A | N/A | N/A | N/A |
| resistance | effect | | | sticky | | | | |
| 24 hour MEK | Lifted, | Lifted, | Sticky, | Sticky, | N/A | N/A | N/A | N/A |
| spot resistance | sticky | sticky, tore | tore | tore | | | | |
| | | through | | | | | | |
| | | paper | | | | | | |

The following examples show that finished coating formulations may be useful with the invention for reduction of VOCs.

### Example 32

### 2K Solvent-Based Acrylic Coating

To a mixing vessel equipped with an agitator blade, about 35% by weight of a ketone solvent blend was added. To this solvent blend was added 0.042% by weight of a 10% (wt) solution of dibutyl tin dilaurate catalyst and 2.3% by weight UV absorber. Finally, a blend of polyols (comprising 42.8% acrylic polyol Acrylamac 232-1700 available from Resolution Technologies, Carpentersville, Ill., and 15.5% of an acrylic polyol having a number average molecular weight of about 1900, a polydispersibility of about 2.5, and a hydroxyl number of about 130, and a cellulose acetate butyrate polyol having a number average molecular weight of about 30,000, a butyryl content of about 52%, an acetyl content of about 2% and a hydroxyl content of about 1.8%) were added. The blend was agitated until dissolved.

Example 33 shows the incorporation of water into the coating of Example 32, while Examples 34 and 35 compare crosslinking of the standard solvent-based coating to the water-incorporated coating dispersion.

### Example 33

### Aqueous 2K Acrylic Coating

About 42 grams of the composition of Example 32 and about 3 grams of Lubrizol OS#47550AF were mixed well. About 55 grams of deionized water was added with medium agitation, resulting in an emulsion having a non-volatile volume of 21.17%. The sample dispersed fine, showed slight separation, but mixed back together well.

### Example 34

### Crosslinked Acrylic Solvent-Based Coating

About 5.6 grams of the crosslinker Desmodur N3300 was added to 44.4 grams of the composition of Example 32 and mixed well. The non-volatile volume was 46.86%.

### Example 35

### Cross-Linked Aqueous Acrylic Coating

About 1.8 grams of Desmodur N3300 was added to 33.33 grams of the composition of Example 33 with medium agitation. The non-volatile volume was 24.53%.

A 1.5 mil drawdown was made on Leneta Form 7B with Examples 33 and 35, while a 3 mil drawdown was made on Leneta Form 7B with Examples 34 and 36. The films were allowed to air dry 7 days and then evaluated for stain and solvent resistance. The results are detailed in the following table.

TABLE 31
Stain and Chemical Resistance Results
of Films Obtained From Examples 32-35

| Example | 32 | 33 | 34 | 35 |
|---|---|---|---|---|
| Red Marker | 44.85 | 34.64 | 3.0 | 8.32 |
| Resistance, Δa | | | | |
| 1 hr Mustard | 17 | 15.61 | 11.82 | 13.29 |
| Resistance, Δb | | | | |
| 24 hr Detergent | Hazy | Hazy | No effect | Hazy |
| Resistance | | | | |
| 24 hr Ethanol | Lifted, | Lifted, | No effect | Hazy |
| Resistance | tore paper | coating removed | | |
| 24 hr MEK | Lifted, | Lifted; | Lifted, | Lifted, |
| Resistance | tore paper | tore paper | tore paper | tore paper |

Example 36, below is a nitrocellulose lacquer formulation, while Example 37 is a formulation showing the dispersion of water into the lacquer.

### Example 36

### Nitrocellulose Lacquer Formulation

To a mixing vessel equipped with an agitator blade was charged about 10% by weight of an alkyd solution of a mixture of castor and sunflower alkyds, about 9% by weight of a mixture of ½ second and ¼ second nitrocellulose wet with isopropanol, about 2.5% by weight diisonyl phthalate, and about 78% by weight organic solvent. The lacquer was mixed until a uniform, clear solution was obtained.

### Example 37

### Aqueous Nitrocellulose Lacquer Formulation

About 3 grams of Lubrizol OS#47550AF was added to about 42 grams of the lacquer formulation of Example 36, and mixed well. Then, about 55 grams of deionized water was added with medium agitation. The viscosity (at 80° F., #2 Zahn, signature cup) was 15.53 sec and the non-volatile volume was 7.64%.

The aqueous formulation went together well, and was stable for about 1 month. The sample also did not form a uniform film. Improvements are expected with the use of slower evaporating, more hydrophobic solvent combinations.

Example 38, below displays an acid cure coating formulation, and Example 39 gives an example of incorporating water into the Example 38 formulation.

### Example 38

### Acid-Cure Coating Intermediate Formulation

To a mixing vessel equipped with an agitator blade, was added 39.83% by weight of a solvent mixture of esters, ketones, and aromatic hydrocarbons. To this mixture was added 21.18% by weight of a mixture of primary alcohols and 2.85% of a hydroxyl modified vinyl chloride/vinyl acetate polymer having a vinyl chloride content of about 81%, a vinyl acetate content of about 4%, a hydroxylalkyl acrylate content of about 15% with a hydroxyl value of about 66 and a number average molecular weight of about 15000; and 2.85% of a cellulose acetate butyrate polyol having a number average molecular weight of about 30,000, a butyryl content of about 52%, an acetyl content of about 2% and a hydroxyl content of about 1.8%. The blend was mixed until the hydroxyl functional copolymer polyol was dissolved, and then 15.22% by weight of a coconut alkyd was added, followed by 18.07% by weight of a blend of aminoplast crosslinkers of urea-formaldehyde and melamine formaldehyde. The blend was mixed until uniform and clear.

### Example 39

### Aqueous Acid-Cure Formulation

About 3 grams of Lubrizol OS#47550AF and 42.35 grams of the formulation of Example 38 was mixed well. About 55 grams of deionized water was then added with medium agitation. The non-volatile volume was 12.72%.

The formulation of Example 39 went together well and remained stable except for a slight separation that could easily be restirred. The sample of Example 39 was catalyzed with 0.94% (wt) para-toluene sulfonic acid and a film applied with a 30 RDS draw down bar. The resultant coating cured to a soft, slightly yellow film upon air dry.

Example 40 shows a CAB/Acrylic coating formulation. Example 41 is an example of incorporating water into the Example 40 formulation.

Example 40. CAB/Acrylic Coating

| Item | Wt/grams |
|---|---|
| Toluene | 28 |
| VM&P Naphtha | 36 |
| CAB 551.2 | 40 |
| Paraloid B-66 | 28 |
| Butyl Acetate | 36 |
| Methyl ethyl ketone | 30 |
| Butanol | 44 |
| Methyl n-amyl ketone | 92 |
| Ethanol (Duplicating Fluid 5/95) | 49 |
| Santicizer 160 | 12 |
| SF-69 (1% in Xylene) | 2.00 |
| Total | 397 |
| Non-Volatile Volume | 15.32% |

Example 41. Dispersion of Water into Example 40

| Item | Wt/grams |
|---|---|
| Example 40 | 42.35 |
| Lubrizol OS#47550AF | 2.90 |
| Mixed well, then added with medium agitation | |
| DI water | 54.74 |
| Total | 99.99 |
| Non-volatile volume | 9.89% |

Example 41 went together well. A 30 RDS draw down resulted in incomplete film formation.

The following examples show how water can be emulsified directly, with subsequent addition of various coatings such as UV coatings, and show how the addition of chlorinated polyolefin (CPO) helps improve incorporation of such items and improve cure of UV curable formulations.

Example 42 displays an emulsified water sample. Example 43 displays a UV curable coating, and Example 44 shows how the UV curable coating may be added to the emulsified water Example 42. Examples 45 and 46 show the results of emulsifying water directly into the UV cure coating.

Example 42 - Emulsified Water

| Item | Wt/grams |
|---|---|
| Solvesso 100 | 28.62 |
| Xylene | 24.34 |
| Lubrizol OS# 47550AF | 3.63 |
| Mixed well, then added with medium agitation | |
| DI water | 68.43 |
| Total | 125.02 |
| Viscosity @80 F., #2Zahn, signature cup | 14.09 sec |

Example 43 - UV Coating

| Item | Wt/grams |
|---|---|
| Sartomer SR 344 | 49.28 |
| TMPTA-N | 20.02 |
| Irgacure 184 | 6.54 |
| TegoWet 500 | 0.58 |
| Astrocure 78 | 123.58 |

Example 44 - Formulation Incorporating
Example 44 into Example 43

| Item | Wt/grams |
|---|---|
| Example 42 | 30 |
| Example 43 | 3 |
| Total | 33 |

Goes together well

Example 45 - Comparison Formulation Showing
Incorporation of Water into UV Coating

| Item | Wt/grams |
|---|---|
| DPGDA | 21.36 |
| TMPTA | 10.68 |
| Irgacure 184 | 3.01 |
| Astrocure 78 | 43.27 |
| Lubrizol OS#47550AF | 4.06 |
| Mixed well, then added with medium agitation | |
| DI water | 76.64 |
| Total | 159.03 |

The sample appeared to have stayed together initially after the water was added, but after mixing for 10 minutes, the dispersion separated with a sponge-like appearance.

Example 46 - Comparison Formulation Showing
Incorporation of Water into UV Coating

| Item | Wt/grams |
|---|---|
| Solvesso 150 | 10.68 |
| Methyl n-amyl ketone | 10.68 |
| TMPTA | 10.68 |
| Irgacure 184 | 2.16 |
| Astrocure 78 | 43.27 |
| Lubrizol OS#47550AF | 4.06 |
| Mixed well, then added with medium agitation | |
| DI water | 76.64 |
| Total | 158.17 |

The sample started jelling after 37 grams of water was added and completely jelled after 55 grams of water.

Example 47 shows a UV curable coating formulation and Example 48 shows the incorporation of Example 47 into Example 42.

Example 47 - UV Curable Coating

| Item | Wt/grams |
|---|---|
| Sartomer SR 344 | 49.28 |
| TMPTA-N | 20.02 |
| Irgacure 184 | 6.54 |
| TegoWet 500 | 0.58 |
| Ebecryl 3212 | 123.58 |

Example 48 - Formulation Incorporating
Example 47 into Example 42

| Item | Wt/grams |
|---|---|
| Example 42 | 30 |
| Example 47 | 3 |
| Total | 33 |

Goes together well

The coating of Example 48 was compared to the coating of Example 24, Table 28—B which utilized CPO to make the emulsified water. The samples were applied to Leneta Form N2A with a 20 RDS Rod. The samples were allowed to air flash overnight, and were exposed to 1 hr force dry at 66° C., then were UV cured at 604 mj/cm2 with a medium pressure Hg vapor lamp. The coating of Example 24, Table 28—B produced a more uniform drawdown appearance both after air flash, oven dry, and UV cure. It also cured to a tack free film within 5 seconds out of the UV unit whereas the coating of Example 48 did not cure. Microscopic analysis shows that emulsification of water in the presence of CPO results in improved dispersion uniformity and cure.

Examples 49-51 describe an aqueous primer composition of the invention.

### Example 49

### Water-Based Pigment Dispersion

To a stainless steel mixing vessel was charged 19.80 grams tap water, 8.80 grams Disperbyk 190, 1.0 grams BYK-024, both from BYK-Chemie USA (Wallingford, Conn.), and 0.10 grams Proxel GXL, available from Zeneca Biocides, (Wilmington, Del.). The following was added under agitation: 0.30 grams fumed silica, 18.80 grams aluminum silicate, 13.71 grams Titanium dioxide, and 37.70 grams sodium potassium alumino silicate. The mixture was then mixed at high speed with a dispersing blade to a grind of N.S. 5½-7 as measured on a hegman gage. A pasty, medium viscosity dispersion results.

### Example 50

### Organic Phase Composition

To a stainless steel mixing vessel was charged 100 grams of a 75% solids solution of a medium-Soya alkyd resin, 27.72 grams of a vegetable oil having an iodine value of 120-141 and a saponification value of 180-200, and 5.75 grams of a low molecular weight amine coupled polyisobutylene succan derivative. The blend was mixed for 15 minutes at 100-110 degrees F.

### Example 51

### Aqueous Primer Composition

To a stainless steel mixing vessel was charged 40 grams of the composition of Example 50. To this was added 0.19 grams Nuocure CK 10%, 0.94 grams Nuocure calcium 6%, 0.92 grams Nuocure Zr 12%, all three available from Elementis (East Saint Laths, Ill.). The components were mixed well, and then 182.75 grams of the composition of Example 49 was added under agitation. The mixture was mixed for 10-15 minutes and then 26.12 grams of tap water was added and mixed for another 15 minutes.

A smooth white primer with a VOC of less than 100 g/l resulted with a viscosity of 1550 cps at 50 rpm as determined on a Brookfield viscometer with a #6 spindle. The sample was found to be stable for 7 days at 49° C., pass 5 freeze thaw cycles, have good dry and biding properties, and good adhesion.

Table 32 provides a description of various products used in the Examples described above.

TABLE 32
Description of Products in Examples

| Item | Supplier | Composition |
|---|---|---|
| Solvent 150 | Exxon Mobil | Aromatic containing petroleum hydrocarbon |
| | Houston TX | |
| Paraffin wax R | Moore and Munger | Fully refined paraffin wax - petroleum hydrocarbons |
| 2531 | Shelton, CT | |
| Lubrizol 47550AF | Lubrizol | low molecular weight amine coupled PBU |
| | Wickliffe, OH | [Polyisobutylene] succan derivative and is oil free, |
| | | i.e. ethanoldiethonium polyisobutenyl |
| | | triethylaminosuccinate |
| Irganox 1010 | Ciba | Tetrakis[methylene(3,5-ditert-butyl-4-hydroxyhydro |
| | Tarrytown, NY | cinnamate)methane |
| Foamtrol 110 | Ultra Additives | Organosiloxane polymer defoamer |
| | Paterson, NJ | |
| PolyFox PF3320 | Omnova Solutions | Fluorinated oxetane oligomer |
| | Akron, OH | |
| Urotuff 19M50 | Reichhold | Oil-modified polyurethane resin |
| | Durham, NC | |
| Busan 1105 | Buckman | 10% (2-Thiocyanomethythio)benzothiazole and 10% |
| | Laboratories | Methylene bis(thiocyanate) |
| | Memphis, TN | |
| Tinuvin 1130 | Ciba | UV absorber |
| | Tarrytown, NY | |
| Michelman 433 | Michelman Inc | Carnauba wax |
| | Cincinnati, OH | |
| Hombitec RM | Sachtleben Chemie | Nano Titanium dioxide dispersion |
| 401LP | New York, NY | |
| Tint-AYD AL600 | Elementis Specialties | Transparent red oxide pigment dispersion in alkyd |
| | Hightstown, NJ | resin |
| Tint-AYD AL499 | Elementis Specialties | Transparent yellow oxide pigment dispersion in |
| | Hightstown, NJ | alkyd resin |
| CAPA 2047A | Solvay | 2-oxepanone, polymer with 1,6-hexanediol |
| | Warrington, Cheshire | |
| | WA4 6HB | |
| Polybd R-20LM | Sartomer | 1,3-butadiene, homopolymer, hydroxy terminated |
| resin | Exton, PA | |
| MetaCure T-12 | Air Products Inc | Dibutyl tin dilaurate |
| | Allentown, PA | |
| PM Acetate | Eastman Chemical | 1-methoxy-2-propane acetate |
| | Kingsport, TN | |
| CAB 551.2 | Eastman Chemical | Cellulose acetate butyrate |
| | Kingsport, TN | |
| Tinuvin 328 | Ciba | 2-(2-hydroxy-3,5-di-(tert)-amyl phenyl benzotriazole |
| | Tarrytown, NY | |
| BYK 320 | BYK Chemie | Polyether modified methylalklpolysiloxane |
| | Wallingford, Conn | copolymer |
| Acrylamac 232-1700 | Eastman Chemical | Acrylic polyol |
| | Kingsport, TN | |
| PolyFox PF6320 | Omnova Solutions | Fluorinated polyether |
| | Akron, OH | |
| Chempol 801-0127 | Cook Composite | Coconut oil alkyd polymer |
| | Polymers | |
| | Kansas City, MO | |
| Duramac 207-2742 | Eastman Chemical | Soya oil alkyd polymer |
| | Kingsport, TN | |
| DINP | CP Hall | Diisonyl phthalate |
| | Memphis, TN | |
| MAK | Eastman Chemical | Methyl n-amyl ketone |
| | Kingsport, TN | |
| Desmodur N 3300 | Bayer Materials | 1,6-hexamethylated diisocyanate based |
| | Science | polyisocyanate |
| | Pittsburgh, PA | |
| Bayhydur VP | Bayer Materials | 1,6-hexamethylene diisocyanate |
| LS2336 | Science | |
| | Pittsburgh, PA | |
| CE7103 | Solutia/UCB | Melamine-formaldehyde resin |
| | Springfield, MA | |
| PTSA | Cytec Industries, Inc | Cycat 4040 - Paratoluene sulfonic acid solution, |
| | West Paterson, NJ | 40% in isopropanol |
| Acryflow P120 | Lyondell Chemical Co. | Acrylic polyol |
| | Houston, TX | |
| PolyFox T | Omnova Solutions, | Fluorinated Polyether |
| | Akron, OH | |
| Paraloid AU608S | Rohm & Haas | Acrylic polyol solution |
| | Philadelphia, PA | |
| Roskydal 502BA | Bayer Materials | Unsaturated polyester resin in butyl acetate |
| | Science | |
| | Pittsburgh, PA | |
| Duramac 207-1205 | Eastman Chemical | Coconut oil based alkyd |
| | Kingsport, TN | |
| Slip-AYD SL145E | Elementis Specialties | Paraffin wax emulsion |
| | Hightstown, NJ | |
| EB49 | Specialty Polymers | Acrylic styrene Polymer |
| | Woodburn, Oregon | |
| SF-69 | General Electric | Polydimethylsiloxane |
| | Waterford, NY | |
| Xylene | Exxon Mobil | Aromatic hydrocarbon |
| | Houston, TX | |
| Mineral Spirits | Chemcentral | Petroleum hydrocarbon solvent |
| | Jamestown, NC | |
| Mineral Spirits | Chemcentral | Petroleum hydrocarbon solvent |
| 66/3 | Jamestown, NC | |
| DC200 | Dow Corning | Polydimethylsiloxane 1000 CST |
| | Midland, MI | |
| FC129 | 3M | Potassium fluoroalkyl carboxylate mixture |
| | St Paul, MN | |
| CP 343-4 | Eastman Chemical | 25% solution of chlorinated polyolefin in xylene |
| | Kingsport, TN | |
| NAPA acrylic | Napa auto parts store | Commercial 2K automotive acrylic polyurethane |
| urethane | | |
| MSU 475 Hardner | Napa auto parts store | Commercial 2K automotive polyurethane crosslinker |
| MPK | Eastman Chemical | Methyl propyl ketone |
| | Kingsport, TN | |
| SAA | Lyondell Chemical Co | Styrene allyl alcohol |
| | Houston, TX | |
| Propylene Glycol | Lyondell Chemical Co | 1,2-propanediol |
| | Houston, TX | |
| Natrosol 250 | Aqualon/Hercules | Modified hydroxyl ethylcellulose |
| HHBR PA | Wilmington, DE | |
| Ammonia | Sigma-Aldrich | Ammonium hydroxide |
| | ST Louis, MO | |
| Chempol 821-3660 | Cook Composite | Acrylic modified alkyd dispersion |
| | Polymers | |
| | Kansas City, MO | |
| Surfynol 104 DPM | Air Products Inc | Acetylenic diol in dipropylene glycol monomethyl |
| | Allentown, PA | ether |
| Laponite RDS | Southern Clay | Hydrous sodium lithium magnesium silicate |
| | Products | modified with tetra sodium pyrophosphate |
| | Gonzales, TX | |
| CMCAB 641.2 | Eastman Chemical | Carboxymethyl cellulose acetate butyrate |
| | Kingsport, TN | |
| AMP-95 | Angus/Dow | 2-amino-2-methyl-1-propanol |
| | Houston, TX | |
| SCT275 Thickener | Rohm & Haas | Polyurethane resin thickening agent solution |
| | Philadelphia, PA | |
| Tergitol XD | Dow/Union Carbide | Polyalkylene glycol ether |
| | Houston, TX | |
| Flexipel s-22 WS | Innovative Chemical | Perfluorinated polymer in mineral spirits |
| | Technologies | |
| | Cartersville, GA | |
| BYK333 | BYK Chemie | Polyether modified dimethylpolysiloxane |
| | Wallingford, Conn | |
| Tint AYD AL505 | Elementis Specialties | Burnt Sienna Pigment dispersion in alkyd resin |
| | Hightstown, NJ | |
| 2,2,4-Trimethyl- | Eastman Chemical | Plasticizer/solvent |
| 1,3-pentanediol | Kingsport, TN | (Eastman TXIB) |
| diisobutyrate | | |
| Aromatic 150 | Exxon Mobil | Aromatic containing petroleum hydrocarbon |
| (Same as Solvent | Houston TX | |
| 150) | | |
| Oxsol 100 | Occidental Chemical | Parachlorobenzotrifluoride |
| | Corp | |
| | Dallas, TX | |
| Astrocure 78 | Zircon Corporation | Polyester oligomer |
| | Collierville, TN | |
| DPGDA | BASF | Dipropylene glycol diacrylate |
| | Charlotte, NC | |
| Laromer 8967 | BASF | Amine modified polyether acrylate |
| | Charlotte, NC | |
| Laromer PE55F | BASF | Polyester acrylate |
| | Charlotte, NC | |
| Photomer 6210 | Cognis Corp | Aliphatic urethane acrylate |
| | Ambler, PA | |
| Ebecryl 264 | UCB RadCure | Aliphatic urethane triacrylate |
| | Smyrna, GA | |
| Ebecryl 3212 | UCB RadCure | Epoxy acrylate |
| | Smyrna, GA | |
| Sartomer CN972 | Sartomer | Aromatic urethane |
| | Exton, PA | |
| Actilane 505 | Akzo Nobel Resins | Polyester acrylate |
| | Louisville, KY | |
| Roskydal UA VP | Bayer Materials | Aliphatic urethane acrylate |
| LS2258 | Science | |
| | Pittsburgh, PA | |
| DC 840 resin | Dow Corning | Silicone polymer |
| | Midland, MI | |
| NuoCure CK | Degussa | Cobalt dryer complex |
| | Somerset, NJ | |
| Santolink XI100 | Solutia | Polyallyl glycidyl ether oligomer |
| | Springfield, MA | |
| Roskydal 502BA | Bayer Materials | Polyester resin |
| | Science | |
| | Pittsburgh, PA | |
| Resimene 2040 | Solutia/UCB | Styrene allyl alcohol modified methylated melamine |
| | Springfield, MA | solution |
| B11P485 Cocoa | Proprietary | Proprietary UV cure stain |
| UV Stain | | |
| Store bought H₂O₂ | | Aqueous hydrogen peroxide |
| Lubrizol | Lubrizol Corp | low molecular weight amine coupled PBU |
| OS#47550AF | Wickliffe, OH | [Polyisobutylene] succan derivative and is oil free |
| 1X.5LT | | |
| Soy salad oil | Alnor oil co | Refined soybean oil |
| | Valley Stream, NY | |
| Aerosil R972 | Degussa | Silane, dichloromethyl rxn products with silica |
| | Parsippany, NJ | |
| Cycat 296-9 | Cytec Industries | Phosphate ester catalyst |
| | West Paterson, NJ | |
| Nytal 300 | R T Vandebilt | Industrial talc |
| | Norwalk, CT | |
| Eagle Series 2000 | Eagle Sales | Burnt Umber tint paste |
| WB1711 Burnt | ST Louis, MO | |
| Umber | | |
| Joncryl 95 | S C Johnson Co | Acrylic polymer emulsion |
| | Sturtevant, WI | |
| Ethylene glycol | Eastman Chemical | Solvent |
| dibutyl ether | Kingsport, TN | |
| Foamaster S | Cognis | Mineral oil defoamer |
| | Ambler, PA | |
| Proxel GXL | Avecia | 20% solution of 1,2-benzisothiazolin-3-one |
| | Charlotte, NC | |
| Toluene | Vopak USA | Toluene |
| | Martinsville, VA | |
| Isobutyl alcohol | Eastman Chemical | 2-methyl-1 propanol |
| | Kingsport, TN | |
| Isopropyl alcohol | Vopak USA | 2-propanol |
| | Martinsville, VA | |
| VM&P Naptha | Vopak USA | Petroleum hydrocarbon distillate |
| | Martinsville, VA | |
| ½ sec NC | Aqualon/Hercules | Cellulose nitrate wet with 2-propanol |
| | Wilmington, DE | |
| ¼ sec NC | Aqualon/Hercules | Cellulose nitrate wet with 2-propanol |
| | Wilmington, DE | |
| Butyl acetate | Eastman Chemical | Butyl acetate |
| | Kingsport, TN | |
| GE SF69 | General Electric | Polydimethylsiloxane |
| | Waterford, NY | |
| Paraloid B66 | Rohm & Haas | Acrylic polymer |
| | Philadelphia, PA | |
| N-butyl acetate | Eastman Chemical | Butyl acetate |
| (same as butyl | Kingsport, TN | |
| acetate) | | |
| Ethyl alcohol | Chemcentral | Denatured alcohol - Duplicating fluid 5/95 |
| | Jamestown, NC | |
| n-butyl alcohol | Eastman Chemical | 1-butanol |
| | Kingsport, TN | |
| MEK | Vopak USA | 2-butanone |
| | Martinsville, VA | |
| Santicizer 160 | Ferro | Butyl benzyl phthalate |
| | Walton Hills, OH | |
| TMPTA | BASF | Trimethylol propane triacrylate |
| | Charlotte, NC | |
| Irgacure 184 | Ciba | Hydroxyl cyclohexyl phenyl ketone |
| | Tarrytown, NY | |
| Solvesso 100 and 150 | Exxon Mobil | Aromatic containing petroleum hydrocarbons |
| | Houston, TX | |

It will be apparent to those skilled in the relevant art that the disclosed invention may be modified in numerous ways and may assume embodiments other than the preferred form specifically set out and described above. Accordingly, it is intended by the appended claims to cover all modifications of the invention which fall within the true spirit and scope of the invention.

What is claimed is:

1. An aqueous coating composition comprising:
an organic phase comprising a substrate coating resin;
an aqueous phase; and
an emulsifying amount of an emulsifier selected from the group consisting of a polyolefin aminoester, a substituted alkanolamine, a mixture of a polyolefin aminoester and a substituted alkanolamine, a polyalkylene glycol ether having a molecular weight of about 2000 to about 4000, and Videt ME-80 anionic emulsifier.

2. The coating composition of claim 1, wherein the emulsifier is selected from the group consisting of ethanoldiethonium polyisobutenyl triethylaminosuccinate, TEA-diethanolaminoethyl polyisobutenyl succinate, glyceryl polyisobutenyl succinate, and mixtures thereof.

3. The coating composition of claim 1, wherein the emulsifier is a polyalkylene glycol ether, and wherein the polyalkylene glycol ether is an alkyl ethylene oxide/propylene oxide copolymer having a molecular weight of about 3000.

4. The coating composition of claim 1, wherein the emulsifier is Videt ME-80 anionic emulsifier.

5. The coating composition of claim 1, wherein the substrate coating resin is selected from one or more of the group consisting of a silicone-modified polymer, a perfluorinated polymer, a chlorinated polyolefin, a non-chlorinated polyolefin, a hydroxyl-functional polymer, an acrylic, a polyester, a modified polyester, a polyether, an acrylate-functional resin, an acrylated acrylic, an acrylated polyester, an acrylated polyether, an acrylated polyurethane, an acrylated epoxy, an amine-modified acrylated acrylic, an amine-modified polyether, an unsaturated polyester, an allyl-functional polymer, styrene allyl alcohol, a non-water soluble polyol, an air-oxidizable initiator/crosslinker, a phenoplast resin, aminoplast resin, an oil, a fat, a fatty acid, a resin derived from an oil, fat, or fatty acid, an alkyd resin, a modified alkyd resin, a plasticizer, a hydroxyl-terminated polybutadiene resin or derivative thereof, a maleic-modified resin, an ethylene vinyl acetate copolymer, a styrene-butadiene copolymer, a styrene-isoprene copolymer, an acrylic copolymer, a butadiene-based polymer, and an aliphatic or aromatic hydrocarbon resin.

6. The coating composition of claim 1, further comprising one or more additives selected from the group consisting of photoinitiators, defoamers, antioxidants, waxes, colorants, pigments, dyes, rheology modifiers, anti-settling agents, dispersants, antimar agents, UV absorbers, light stabilizers, antioxidants, catalysts, crosslinkers, redox catalysts, flow and leveling agents, wetting agents, catalysts, sunscreens, biocides, plasticizers, and water repellants.

7. The coating composition of claim 1, wherein the organic phase further comprises a solvent.

8. The coating composition of claim 1, wherein the aqueous phase is an aqueous emulsion, dispersion, or solution.

9. A substrate having the coating composition of claim 1 applied thereto.

10. An article of manufacture comprising the coated substrate of claim 9.

11. An aqueous coating additive comprising:
an organic phase comprising one or more hydrophobic additives selected from the group consisting of photoinitiators, defoamers, antioxidants, waxes, dispersants, antimar agents, UV absorbers, light stabilizers, flow and leveling agents, wetting agents, biocides, and water repellants;
an aqueous phase; and
an emulsifying amount of an emulsifier selected from the group consisting of a polyolefin aminoester, a substituted alkanolamine, a mixture of a polyolefin aminoester and a substituted alkanolamine, a polyalkylene glycol ether having a molecular weight of about 2000 to about 4000, and Videt ME-80 anionic emulsifier.

12. The coating additive of claim 11, wherein the organic phase further comprises a solvent.

13. A coating containing the aqueous coating additive of claim 11.

14. A substrate having the coating of claim 13 applied thereto.

15. An article of manufacture comprising the coated substrate of claim 14.

16. A stain comprising the coating composition of claim 1 and one or more additives selected from the group consisting of colorants, pigments, dyes, rheology modifiers, anti-settling agents, dispersants, antimar agents, UV absorbers, light stabilizers, antioxidants, metal complexation catalysts and crosslinkers, redox catalysts, flow and leveling agents, wetting agents, defoamers, catalysts, sunscreens, biocides, water repellants, plasticizers, and waxes.

17. The stain of claim 16, wherein the coating resin is selected from the group consisting of alkyds, oil-modified alkyds, styrenated and vinyl-modified alkyds, silicone-modified alkyds, oil-modified urethanes, soya oil, corn oil, sunflower oil, coconut oil, linseed oil, cottonseed oil, olive oil, tung oil, fish oil, peanut oil, oil-modified acrylics, rosin and rosin esters, maleic-modified resins, hydroxyl-terminated polybutadiene resins and derivatives thereof, aromatic and aliphatic hydrocarbon resins, and plasticizers.

18. A wood substrate having the stain of claim 16 applied thereto.

19. An article of manufacture comprising the wood substrate of claim 18.

20. A primer comprising the coating composition of claim 1 and one or more additives selected from the group consisting of colorants, pigments, dyes, rheology modifiers, anti-settling agents, dispersants, antimar agents, UV absorbers, light stabilizers, antioxidants, metal complexation catalysts and crosslinkers, redox catalysts, flow and leveling agents, wetting agents, defoamers, catalysts, sunscreens, biocides, water repellants, plasticizers, and waxes.

21. The primer of claim 20, wherein the coating resin is selected from the group consisting of alkyds, oil-modified alkyds, styrenated and vinyl-modified alkyds, silicone-modified alkyds, oil-modified urethanes, soya oil, corn oil, sunflower oil, coconut oil, linseed oil, cottonseed oil, olive oil, tung oil, fish oil, peanut oil, oil-modified acrylics, rosin and rosin esters, maleic-modified resins, hydroxyl-terminated polybutadiene resins and derivatives thereof, aromatic and aliphatic hydrocarbon resins, and plasticizers.

22. A wood substrate having the primer of claim 20 applied thereto.

23. An article of manufacture comprising the wood substrate of claim 22.

24. An aqueous adhesion promoter composition comprising:
an organic phase comprising one or more adhesion promoters selected from the group consisting of a chlorinated polyolefin and nonchlorinated adhesion promoter AP 440-1;
an aqueous phase; and
an emulsifying amount of an emulsifier selected from the group consisting of a polyolefin aminoester, a substituted alkanolamine, a mixture of a polyolefin aminoester and a substituted alkanolamine, a polyalkylene glycol ether having a molecular weight of about 2000 to about 4000, and Videt ME-80 anionic emulsifier.

25. A plastic having the composition of claim 24 applied thereto.

26. The plastic of claim 25, wherein the plastic is selected from the group consisting of thermoplastic polyolefin (TPO), polyethylene and polyethylene composites, polypropylene, polypropylene composites, and wood plastic composites.

27. The aqueous adhesion promoter composition of claim 24, further comprising a UV coating or a substrate coating resin.

28. A plastic having the composition of claim 27 applied thereto and cured.

29. A method of coating a substrate comprising providing the aqueous coating composition of claim 1 and applying the composition to the substrate.

30. A method of staining a wood or wood composite substrate comprising providing the stain of claim 16 and applying the stain to the wood substrate.

31. A method of priming a substrate comprising providing the primer of claim 20 and applying the primer to the substrate.

32. A method of applying an adhesion promoter to a plastic comprising providing the aqueous adhesion promoter composition of claim 24 and applying the composition to the plastic.

33. A method of making an aqueous coating composition, comprising forming an emulsion of:
an organic phase comprising a substrate coating resin;
an aqueous phase; and
an emulsifying amount of an emulsifier selected from the group consisting of a polyolefin aminoester, a substituted alkanolamine, a mixture of a polyolefin aminoester and a substituted alkanolamine, a polyalkylene glycol ether having a molecular weight of about 2000 to about 4000, and Videt ME-80 anionic emulsifier, thereby forming the aqueous coating composition.

34. The method of claim 33, wherein the organic phase further comprises a solvent, and wherein forming the emulsion comprises emulsifying the solvent, the aqueous phase, and the emulsifier to form an emulsion, and adding the resin to the emulsion.

35. The method of claim 33, wherein the organic phase comprises a chlorinated polyolefin dissolved in a solvent.

36. A method of making an aqueous coating additive, comprising forming an emulsion of:
an organic phase comprising one or more hydrophobic additives selected from the group consisting of photoinitiators, defoamers, antioxidants, waxes, dispersants, antimar agents, UV absorbers, light stabilizers, flow and leveling agents, wetting agents, biocides, and water repellants;
an aqueous phase; and
an emulsifying amount of an emulsifier selected from the group consisting of a polyolefin aminoester, a substituted alkanolamine, a mixture of a polyolefin aminoester and a substituted alkanolamine, a polyalkylene glycol ether having a molecular weight of about 2000 to about 4000, and Videt ME-80 anionic emulsifier.

37. The method of claim 36, wherein the organic phase further comprises a solvent, and wherein forming the emulsion comprises emulsifying the solvent, the aqueous phase, and the emulsifier to form an emulsion, and adding the hydrophobic additive to the emulsion.
